(19) United States
(12) Patent Application Publication
(10) Pub. No.: US 2025/0284220 A1
(43) Pub. Date: Sep. 11, 2025

(54) IMAGE FORMING APPARATUS

(71) Applicant: SHARP KABUSHIKI KAISHA, Osaka (JP)

(72) Inventors: ATSUSHI UEDA, Osaka (JP); Akito TERAMOTO, Osaka (JP)

(21) Appl. No.: 19/072,065

(22) Filed: Mar. 6, 2025

(30) Foreign Application Priority Data
Mar. 11, 2024 (JP) 2024-037237

(51) Int. Cl. G03G 15/043; G03G 15/04

(52) U.S. Cl. CPC G03G 15/043; G03G 15/0409; G03G 2215/0412

(57) ABSTRACT

An image forming apparatus including an image carrier, a long print head including a board and a lens array, and a tilt adjuster that adjusts a tilt of the print head, further includes a positioning mechanism that positions the print head relative to the image carrier to maintain a constant distance d between the print head and the image carrier, regardless of the tilt of the print head about a swing axis β caused by the tilt adjuster.

### CROSS-REFERENCE TO RELATED APPLICATION

The present application claims priority from Japanese Application JP 2024-037237, the content to which is hereby incorporated by reference into this application.

### BACKGROUND OF THE INVENTION

### 1. Field of the Invention

The present disclosure relates to an image forming apparatus such as a copier, a multifunction peripheral, a printer, and a facsimile device.

### 2. Description of the Related Art

In the related art, there is known an image forming apparatus including an image carrier (for example, a photosensitive drum), a long print head, and a tilt adjuster that adjusts a tilt of a print head about a swing axis along an optical axis direction of a plurality of light-emitting elements.

### SUMMARY OF THE INVENTION

The well-known image forming apparatus including the tilt adjuster of the print head has the following disadvantages. The disadvantages will be explained below with reference to FIGS. 20A to 20C.

FIGS. 20A to 20C are plan views (top) and front views (bottom) illustrating one example, another example, and yet another example of a distance d (d1, d2, d3) between a photosensitive drum 1 and a print head 3 in a well-known image forming apparatus 100X including a tilt adjuster of the print head 3. In FIGS. 20A to 20C, a symbol FL indicates a main body frame.

As illustrated in FIGS. 20A to 20C, the long print head 3 includes a plurality of light-emitting elements 31 to 31 arranged in a line along a longitudinal direction L, which emit light to expose the photosensitive drum 1 (an example of an image carrier). A lens array 32 focuses light emitted by the plurality of light-emitting elements 31 to 31 onto the photosensitive drum 1.

In such a well-known image forming apparatus 100X, as illustrated in FIGS. 20B and 20C, skewing and the like of a sheet P such as a recording sheet may occur. The tilt adjuster adjusts a tilt of the print head 3 around a swing axis β along an optical axis direction N of the plurality of light emitting elements 31 to 31 in accordance with the skewing and the like of the sheet P or the like. In such an example, the swing axis β is located outside the print head 3 in a rotation axis direction X of the photosensitive drum 1.

A focal depth of the print head 3 serving as an exposure device using the plurality of light-emitting elements 31 to 31 and the lens array 32, is a value (for example, about 0.1 mm) smaller than that of another type of exposure device (for example, an optical scanning device being an exposure device using a light deflector and an fθ lens). Thus, it is necessary to position the print head 3 relative to the photosensitive drum 1 so that a distance between the photosensitive drum 1 and the print head 3 is constant.

However, in the well-known image forming apparatus 100X, in adjusting a tilt of the print head 3 around the swing axis β, the print head 3 moves parallel to a linear direction T perpendicular to both the rotation axis α and the swing axis β as viewed from the rotation axis direction X of the photosensitive drum 1, so that the distance d (d1, d2, d3) between the photosensitive drum 1 and the print head 3 varies depending on a position of the print head 3 in the linear direction T (d1<d2<d3). For example, if the focal depth is 0.1 mm, even when a focus of the lens array 32 on a surface 1a of the photosensitive drum 1 is adjusted to match the configuration illustrated in FIG. 20A, the distance d (d2) between the photosensitive drum 1 and the print head 3 in the configuration illustrated in FIG. 20B, which is moved horizontally by +1 mm (to the left in an example of FIG. 20A), is d1+0.258 mm. That is, as illustrated in FIGS. 20B and 20C, as the print head 3 moves more in the linear direction T, the distance d (d1<d2<d3) between the photosensitive drum 1 and the print head 3 is greater, and thus, the image formed on the surface 1a of the photosensitive drum 1 is out of focus. Such a phenomenon is more pronounced as the diameter (curvature) of the photosensitive drum 1 is smaller as the image forming apparatus 100X is more compact.

Therefore, an object of the present disclosure is to provide an image forming apparatus capable of maintaining a constant distance between a print head and an image carrier, regardless of a tilt of the print head around a swing axis caused by a tilt adjuster.

In order to solve the above problem, an image forming apparatus according to one aspect of the present disclosure is an image forming apparatus including an image carrier, a print head having a long length and including a board including a plurality of light-emitting elements arranged in a line and a lens array that focuses light emitted by the plurality of light-emitting elements onto the image carrier, and a tilt adjuster that adjusts a tilt of the print head about a swing axis along an optical axis direction of the plurality of light-emitting elements, in which the image forming apparatus further includes a positioning mechanism that positions the print head relative to the image carrier to maintain a constant distance between the print head and the image carrier, regardless of the tilt of the print head about the swing axis caused by the tilt adjuster.

According to the present disclosure, it is possible to maintain a constant distance between a print head and an image carrier, regardless of a tilt of a print head about a swing axis caused by a tilt adjuster.

### BRIEF DESCRIPTION OF THE DRAWINGS

FIG. 1 is a cross-sectional view illustrating an image forming apparatus according to the present embodiment.

FIG. 2 is a perspective view illustrating an example of a print head and an example of a tilt adjustment mechanism provided on a main body frame in the image forming apparatus according to the present embodiment, as viewed obliquely from above on a front side.

FIG. 3 is a perspective view of the print head illustrated in FIG. 2 being supported by a swinger, as viewed obliquely from above on the front side.

FIG. 4A is a perspective view of the print head as viewed obliquely from above on a back side.

FIG. 4B is a perspective view of the print head illustrated in FIG. 4A as viewed obliquely from below on the front side.

FIG. 4C is an exploded perspective view of the print head illustrated in FIG. 4A as viewed obliquely from above on the front side.

FIG. 4D is an exploded perspective view of the print head illustrated in FIG. 4A as viewed obliquely from below on the back side.

FIG. 5A is a cross-sectional perspective view of the print head as viewed obliquely from above on the front side.

FIG. 5B is a cross-sectional view of the print head.

FIG. 5C is a schematic diagram clearly illustrating the cross-sectional view illustrated in FIG. 5B.

FIG. 5D is a plan view illustrating a state in which a flexible circuit board extends in a straight line in a light-emitting element board, the flexible circuit board, and a printed wiring board included in the print head.

FIG. 6A is a perspective view of a swing supporter provided in the swinger, as viewed obliquely from above on the back side.

FIG. 6B is a perspective view illustrating a state in which the swing supporter provided in the swinger is inserted into a through hole in a frame on the back side, as viewed obliquely from above on the back side.

FIG. 6C is an exploded perspective view of the swinger, the swing supporter, and the through hole in a main body frame, as viewed obliquely from below on the back side.

FIG. 7A is a perspective view of a tilt adjuster provided in the main body frame on the front side, as viewed obliquely from above on the front side.

FIG. 7B is a perspective view of the tilt adjuster provided in the main body frame on the front side, as viewed obliquely from below on the back side.

FIG. 7C is an exploded perspective view of the tilt adjuster as viewed obliquely from above on the front side.

FIG. 7D is an exploded perspective view of the tilt adjuster as viewed obliquely from above on the back side.

FIG. 8 is a perspective view of a photosensitive unit, the print head, and the swinger as viewed from above on a left side.

FIG. 9A is a perspective view of a portion of a positioner on one side of the swinger including the print head, as viewed obliquely from above.

FIG. 9B is an exploded perspective view of the print head and the swinger illustrated in FIG. 9A, as viewed obliquely from above.

FIG. 9C is an exploded perspective view of the print head and the swinger illustrated in FIG. 9A, as viewed obliquely from below.

FIG. 9D is a cross-sectional perspective view of the positioner and an area to be positioned on one side illustrated in FIG. 8, as viewed obliquely from above.

FIG. 9E is an enlarged view of the positioner and the area to be positioned on one side in a γ1 portion illustrated in FIG. 8.

FIG. 10A is a perspective view of a portion of the positioner on the other side in the swinger including the print head, as viewed obliquely from above.

FIG. 10B is an exploded perspective view of the print head and the swinger illustrated in FIG. 10A, as viewed obliquely from above.

FIG. 10C is an exploded perspective view of the print head and the swinger illustrated in FIG. 10A, as viewed obliquely from below.

FIG. 10D is a perspective view of the positioner and the area to be positioned on the other side illustrated in FIG. 8, as viewed obliquely from below.

FIG. 10E is an enlarged view of the positioner and the area to be positioned on the other side in a γ2 portion illustrated in FIG. 8.

FIG. 11 is a cross-sectional view illustrating the positioner on the one side abutting against the area to be positioned on the one side.

FIG. 12 is a front view for explaining how a distance between the print head and the photosensitive drum is maintained constant, regardless of a tilt of the print head around the swing axis.

FIG. 13A is an exploded perspective view of the positioner on the one side and a lens holding member, as viewed obliquely from below.

FIG. 13B is a perspective view illustrating the positioner on the one side attached to the lens holding member, as viewed obliquely from below.

FIG. 14A is a perspective view of the positioner on the one side as viewed from above on the back side.

FIG. 14B is a perspective view of the positioner on the one side as viewed from below on the front side.

FIG. 15A is an exploded perspective view of the positioner on the other side and the lens holding member, as viewed obliquely from below.

FIG. 15B is a perspective view illustrating the positioner on the other side attached to the lens holding member, as viewed obliquely from below.

FIG. 16A is a perspective view of the positioner on the other side as viewed from below on the back side.

FIG. 16B is a perspective view of the positioner on the other side as viewed from below on the front side.

FIG. 17 is a side view illustrating another example of a positioning mechanism.

FIG. 18A is a front view of a guide mechanism illustrated in FIG. 17.

FIG. 18B is a rear view of the guide mechanism illustrated in FIG. 17.

FIG. 19 is a front view for explaining that a distance between the print head and the photosensitive drum is maintained constant regardless of a tilt of the print head around the swing axis, and the optical axes of the plurality of light-emitting elements in the print head orient toward the center of rotation of the photosensitive drum.

FIG. 20A is a plan view and a front view illustrating an example of a distance between a photosensitive drum and a print head in a known image forming apparatus including a tilt adjuster of the print head.

FIG. 20B is a plan view and a front view illustrating another example of the distance between the photosensitive drum and the print head in the known image forming apparatus including the tilt adjuster of the print head.

FIG. 20C is a plan view and a front view illustrating yet another example of the distance between the photosensitive drum and the print head in the known image forming apparatus including the tilt adjuster of the print head.

### DETAILED DESCRIPTION OF THE INVENTION

Embodiments according to the present disclosure will be described below with reference to the drawings. In the following description, the same parts are denoted by the same reference numerals. The names and functions of the same parts are also the same. Therefore, detailed descriptions of the same parts will not be repeated.

### Image Forming Apparatus

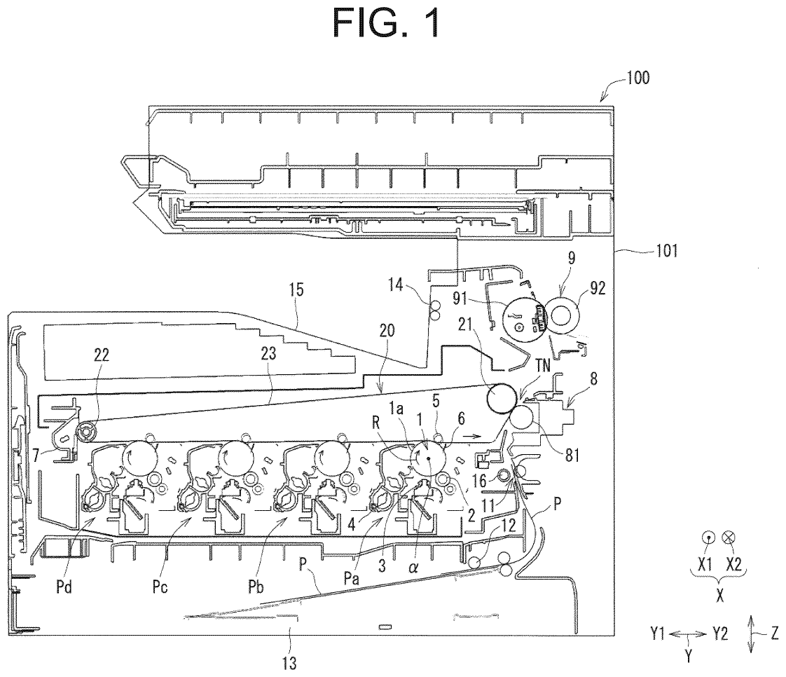

FIG. 1 is a cross-sectional view illustrating an image forming apparatus 100 according to the present embodiment. In the drawings, hereinafter, X is a rotation axis direction of a photosensitive drum 1, X1 is a front side, X2 is a back side, Y is a left-right direction perpendicular to the rotation axis direction X, Y1 is a right side, Y2 is a left side, and Z is an up-down direction perpendicular to the rotation axis direction X and the left-right direction Y.

Image data processed in an image forming apparatus main body 101 of the image forming apparatus 100 corresponds to a color image using colors including black (K), cyan (C), magenta (M), and yellow (Y), or a monochrome image using a single color (for example, black). Thus, four of each of the photosensitive drum 1 (an example of an image carrier), a charger 2, a print head 3, a developing device 4, a primary transfer device 5, and a drum cleaning device 6 are provided to form four types of toner images corresponding to each color, and four image stations Pa, Pb, Pc, and Pd are formed, each corresponding to black, cyan, magenta, and yellow.

In each of the image stations Pa, Pb, Pc, and Pd, the chargers 2 to 2 uniformly charge the surfaces of the photosensitive drums 1 to 1 driven to rotate in a predetermined rotation direction R, to a predetermined potential. The print heads 3 to 3 expose the surfaces of the photosensitive drums 1 to 1 to form electrostatic latent images on the surfaces 1a of the photosensitive drums 1 to 1. The developing device 4 develops the electrostatic latent images on the surface 1a of the photosensitive drums 1 to 1 to form a toner image on the surface 1a of the photosensitive drums 1 to 1. As a result, the toner image of each color is formed on the surface 1a of each of the photoconductor drums 1 to 1. The drum cleaning devices 6 to 6 remove and collect residual toner from the surfaces of the photosensitive drums 1 to 1. The primary transfer devices 5 to 5 sequentially superimpose and transfer the toner image of each color on the surface of each of the photosensitive drums 1 to 1 onto an intermediate transfer belt 23 moved to be revolved by a driving roller 21 and a driven roller 22 in a belt drive device 20, to form a color toner image on the intermediate transfer belt 23. The belt cleaning device 7 removes and collects a residual toner from the intermediate transfer belt 23.

A transfer nip TN is formed between the intermediate transfer belt 23 and a transfer roller 81 of a secondary transfer device 8. The transfer roller 81 of the secondary transfer device 8 pinches a sheet P, such as a recording sheet, transported via a sheet transport path 11 in the transfer nip TN and transports the sheet P together with the intermediate transfer belt 23 while transferring the color toner image on the surface of the intermediate transfer belt 23 onto the sheet P. A fixing device 9 sandwiches the sheet P between a fixing member (in such an example, a fixing belt 91) and a pressure member (in such an example, a pressure roller 92) and applies heat and pressure to fix the color toner image on the sheet P.

The sheet P is pulled out from a paper feed cassette 13 by a pickup roller 12, transported through the sheet transport path 11, passes through the secondary transfer device 8 and the fixing device 9, and is discharged to a discharge tray 15 via a discharge rollers 14. In the sheet transport path 11, a registration roller 16 and the like are arranged. The registration roller 16 temporarily stops the sheet P, aligns the leading edge of the sheet P, and then starts transporting the sheet P in accordance with a timing for transferring the toner image at the transfer nip TN between the intermediate transfer belt 23 and the transfer roller 81.

### Present Embodiment

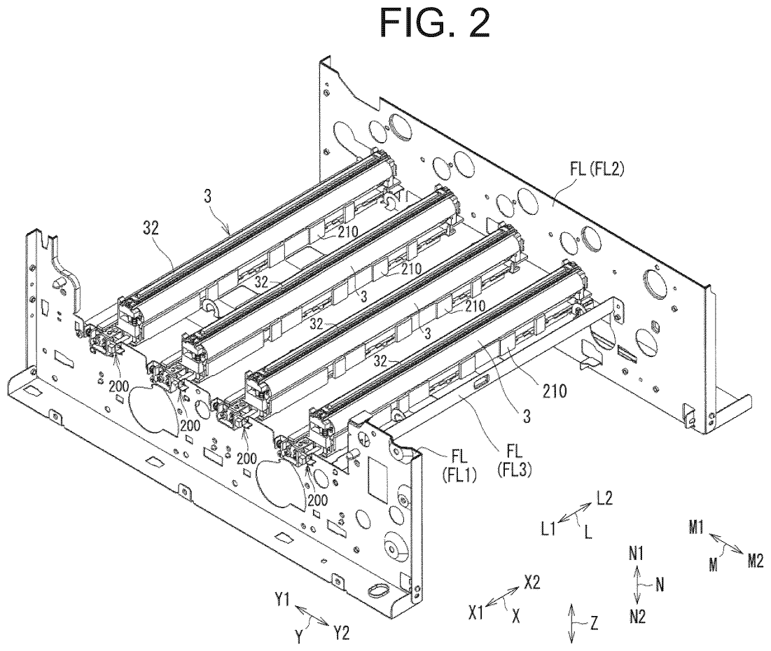

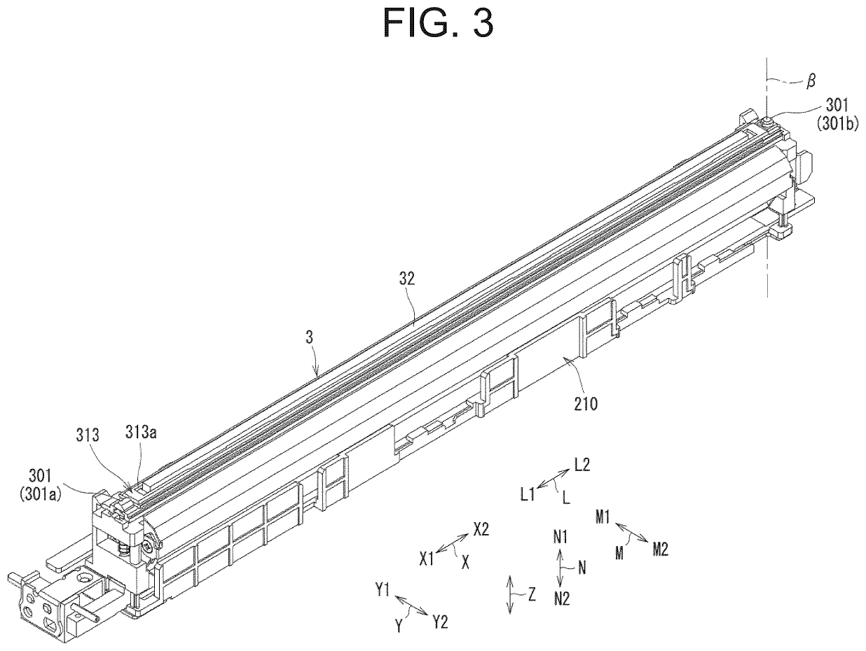

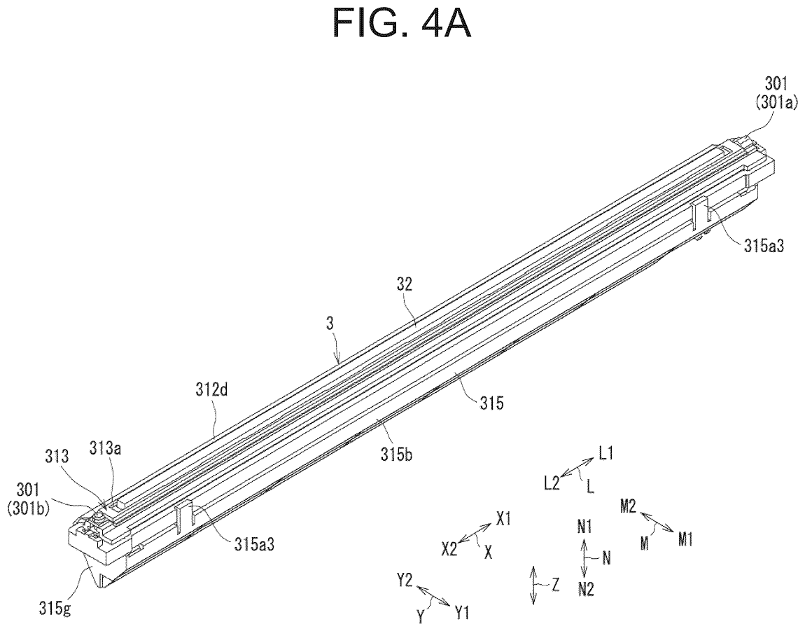

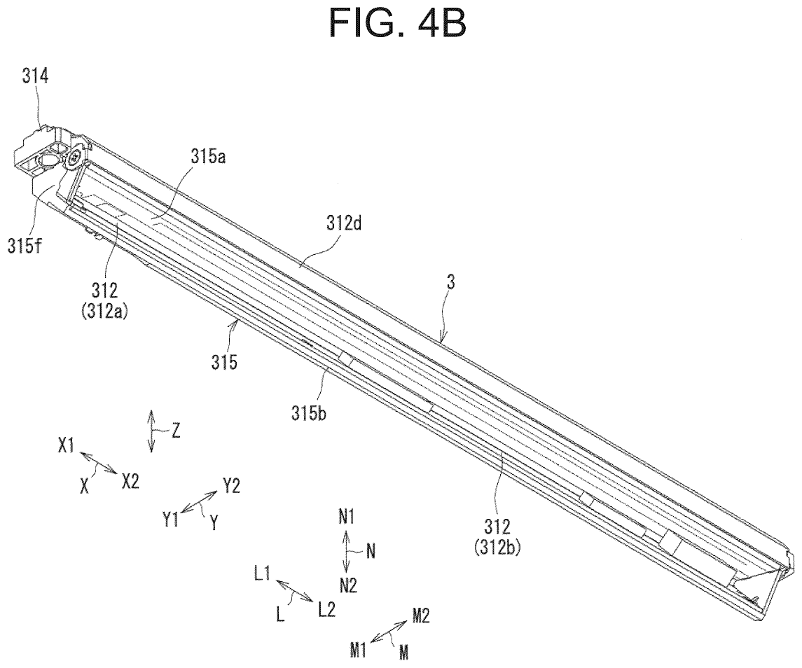

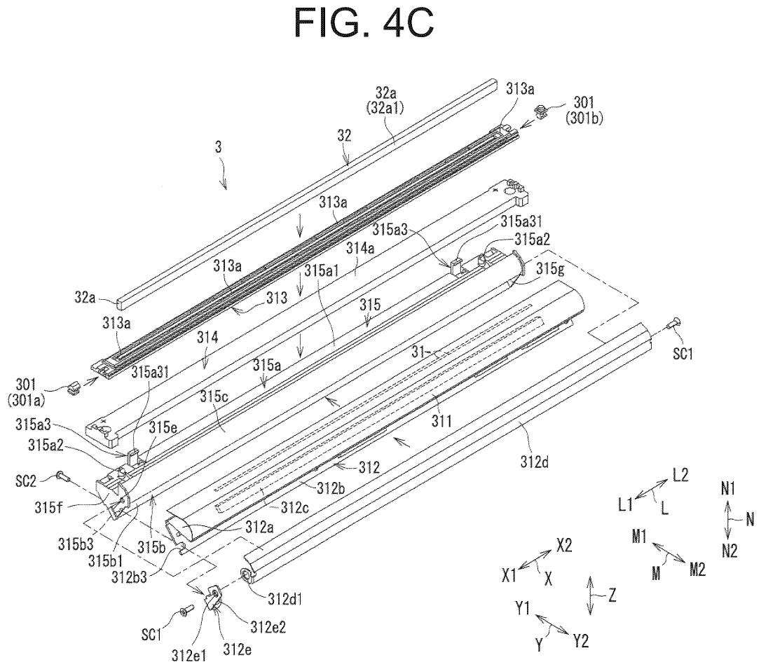

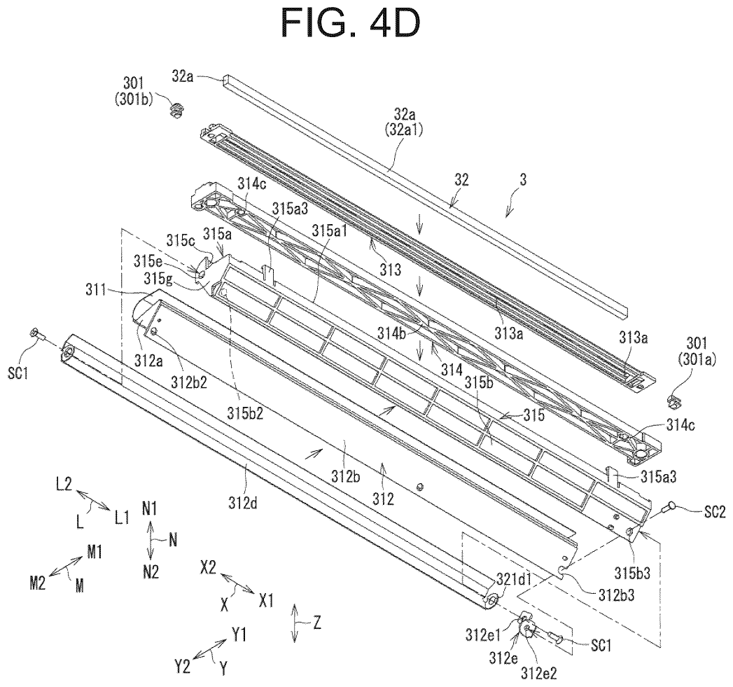

FIG. 2 is a perspective view of an example of the print heads 3 to 3 and an example of a tilt adjustment mechanism 200 provided in a main frame FL (FL1 to FL3) in the image forming apparatus 100 according to the present embodiment, as viewed obliquely from above on the front side X1. FIG. 3 is a perspective view of each of the print head 3 illustrated in FIG. 2 being supported by a swinger 210, as viewed obliquely from above on the front side X1. FIG. 4A is a perspective view of the print head 3 as viewed obliquely from above on the back side X2. FIG. 4B is a perspective view of the print head 3 illustrated in FIG. 4A as viewed obliquely from below on the front side X1. FIGS. 4C and 4D are exploded perspective views of the print head 3 illustrated in FIG. 4A, as viewed obliquely from above on the front side X1 and obliquely from below on the back side X2, respectively.

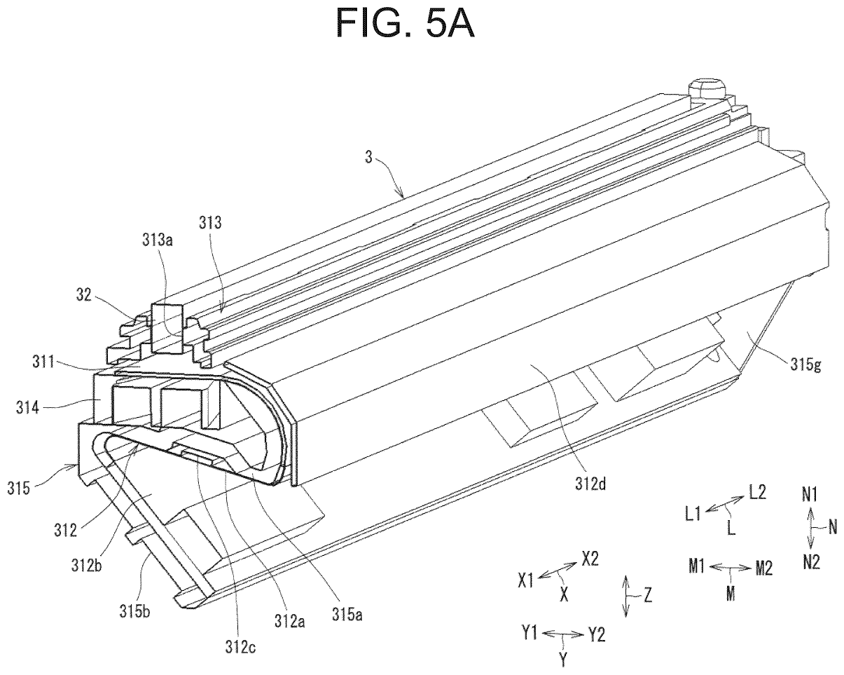

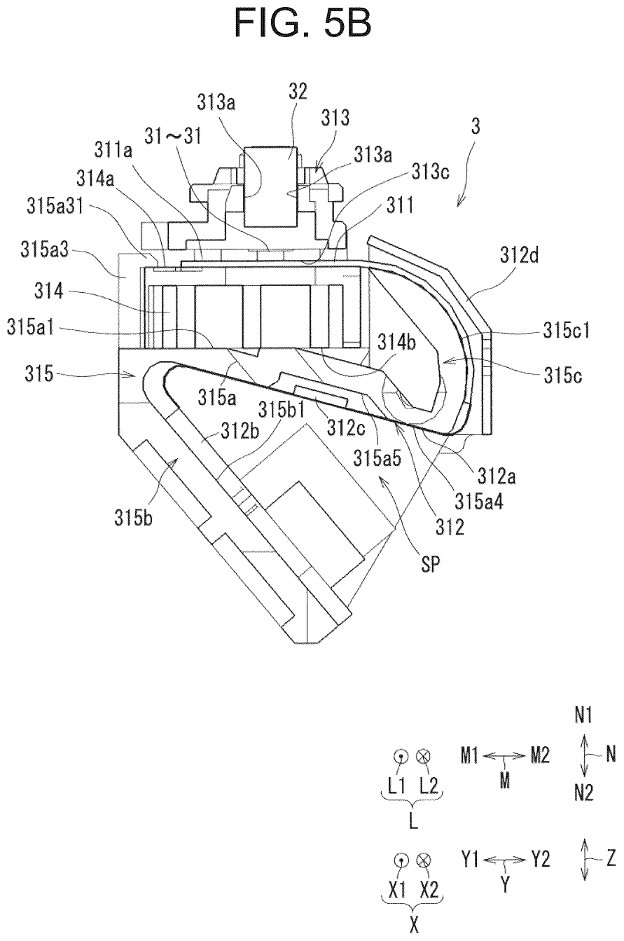

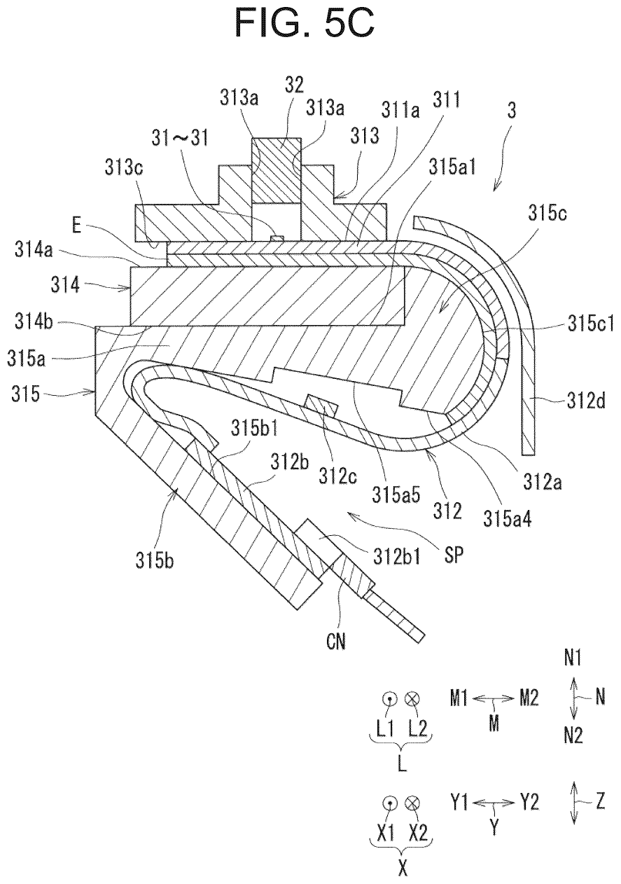

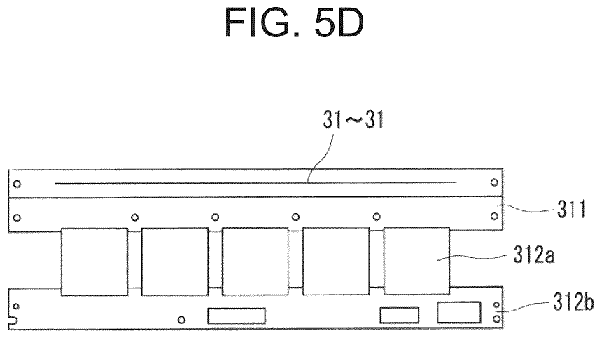

FIG. 5A is a perspective view of the print head 3, as viewed obliquely from above on the front side X1. FIG. 5B is a cross-sectional view of the print head 3. FIG. 5C is a schematic diagram clearly illustrating the cross-sectional view illustrated in FIG. 5B. FIG. 5D is a plan view illustrating a state in which a flexible circuit board 312a extends in a straight line in a light-emitting element board 311, the flexible circuit board 312a, and a printed wiring board 312b included in the print head 3.

The print heads 3 to 3, the swingers 210 to 210, and the like have the same configuration respectively, thus, the print heads 3 to 3 are illustrated in a single drawing in FIGS. 3 to 5D, and in the following description, each of the print heads 3 to 3 and the swingers 210 to 210 will simply be referred to as the print head 3 and the swinger 210.

In the following description, the plurality of light-emitting elements 31 to 31 in the print heads 3 to 3 are each an organic light-emitting diode (OLED), hereinafter simply referred to as OLED. The light-emitting elements 31 to 31 are not limited to OLEDs, but may be light-emitting elements such as inorganic light-emitting diodes (LEDs) or nano-light-emitting diodes (nanoscale light-emitting diodes), which are light-emitting diodes (LEDs) having a size smaller than a micrometer.

The image forming apparatus 100 according to the present embodiment includes the photosensitive drum 1, the print head 3 having a long length, and the tilt adjustment mechanism 200 (an example of a tilt adjustment mechanism) (see FIG. 2). The print head 3 includes the light-emitting element board 311 (an example of a board) and the lens array 32. The light-emitting element board 311 includes the plurality of light emitting elements 31 to 31 (see FIGS. 5B to 5D). The light emitting elements 31 to 31 emit light for exposing the surface 1a of the photosensitive drum 1. The light emitting elements 31 to 31 are arranged next to each other and in a line in the longitudinal direction L of the print head 3. In such an example, the light-emitting element board 311 is a film-like board (flexible OLED panel) mounted with OLED elements (31 to 31). This makes it possible to make the print head 3 smaller and less expensive.

The lens array 32 extends in the longitudinal direction L and focuses light emitted by the light-emitting elements 31 to 31 onto the surface 1a of the photosensitive drum 1. The lens array 32 is arranged to face the light emitting elements 31 to 31. The tilt adjustment mechanism 200 adjusts a tilt of the print head 3 around the swing axis β (see FIG. 3) in which the tilt is along the optical axis direction N of the plurality of light emitting elements 31 to 31. More specifically, the tilt adjustment mechanism 200 adjusts an exposure position of the light emitting elements 31 to 31 relative to the surface 1a of the photosensitive drum 1 by swinging one side L1 around the swing axis β on another side L2 in the longitudinal direction L of the print head 3. In such an example, the swing axis β is located outside the print head 3 in the rotation axis direction X.

### Print Head

As illustrated in FIGS. 5A to 5D, the print head 3 further includes a driving member 312, a lens holding member 313, a fixing member 314 (base member), and a main body member 315. The driving member 312 drives the light emitting elements 31 to 31. The lens holding member 313 holds the lens array 32. The fixing member 314 fixes the lens holding member 313 while the light-emitting element board 311 is fixed. The main body member 315 holds the driving member 312, the lens holding member 313, and the fixing member 314.

In such an example, the driving member 312 includes the flexible circuit board 312a, the printed wiring board (PWB) 312b, a driving circuit element 312c, and a protective member 312d. One end of the flexible circuit board 312a is connected to one end of the light-emitting element board 311, and the other end of the flexible circuit board 312a is connected to one end of the printed wiring board 312b. The flexible circuit board 312a is a flexible circuit board (Chip on Film (COF)) in which a drive circuit element 312c (driver IC) that drives the OLED elements (31 to 31) on the light-emitting element board 311 is mounted on a film. The printed wiring board 312b connected to the flexible circuit board 312a includes an input terminal 312b1 (see FIG. 5C), and is connected to a connector CN (see FIG. 5C) via the input terminal 312b1. The protective member 312d protects an exposed portion of the light-emitting element board 311 and the flexible circuit board 312a. The connector CN is connected to an image processing device (not illustrated) provided in the image forming apparatus main body 101. FIG. 5C illustrates a state in which the light-emitting elements 31 to 31 are provided to protrude from the outer surface of the light-emitting element board 311 (a panel being an example of a board), which is for the purpose of making the light-emitting elements 31 to 31 easier to be understood, but in reality, as illustrated in FIG. 5B, the light-emitting elements 31 to 31 are provided inside the panel (311) not to protrude from the outer surface of the panel (311) (for example, by vapor deposition).

The lens holding member 313 is a frame-shaped member surrounding outer peripheral surfaces 32a to 32a of the lens array 32 along the optical axis direction N (see FIGS. 4C and 4D). Here, the optical axis direction N is a direction (thickness direction) perpendicular to both the longitudinal direction L and a width direction M of the print head 3. The lens array 32 is inserted into an inner surface 313a of the lens holding member 313 that is a frame-shaped member. The lens array 32 includes at least a portion of the outer peripheral surfaces 32a to 32a (in such an example, side surfaces 32a1 and 32a1 along the longitudinal direction L) held by the lens holding member 313, and the outer peripheral surfaces 32a to 32a are bonded at least at some locations (in such an example, a plurality of locations) with an adhesive (for example, an ultraviolet-curing adhesive). Further, a periphery of a bond area between the lens array 32 and the lens holding member 313 is sealed with a caulking agent (caulking resin). This effectively prevents a foreign matter such as dust from entering the lens holding member 313 through the bond area between the lens array 32 and the lens holding member 313.

The fixing member 314 is formed in a rectangular parallelepiped shape. A rear surface 313c of the light-emitting element board 311 (a panel including the light emitting elements 31 to 31) opposite the light emitting elements 31 to 31 is bonded to a surface 314a of the fixing member 314 on a side of the photosensitive drum 1 (one side N1) in the optical axis direction N by an adhesive member E (for example, double-sided adhesive tape) (see FIG. 5C). The rear surface 313c of the lens holding member 313 is fixed to a board surface 311a of the light-emitting element board 311 opposite to the fixing member 314 (a panel including the light emitting elements 31 to 31). A periphery of a bond area between the lens holding member 313 and the light-emitting element board 311 (a panel including the light emitting elements 31 to 31) is sealed with a caulking agent (caulking resin). This effectively prevents a foreign matter such as dust from entering the lens holding member 313 through the bond area between the lens holding member 313 and the light-emitting element board 311 (a panel including the light emitting elements 31 to 31).

The relative positions (positions in the longitudinal direction L, in the width direction M, and in the optical axis direction N) of the plurality of light-emitting elements 31 to 31 and the lens array 32 are positioned and adjusted in advance in the production process using a jig or the like.

The main body member 315 includes a placement area 315a, a bent area 315b, and a board guide 315c. The placement area 315a, the bent area 315b, and a board holder 315d are integrally formed.

The placement area 315a includes the placed fixing member 314 of the print head 3. The placement area 315a includes a placement surface 315a1 on which the fixing member 314 is placed so that a rear surface 314b of the fixing member 314 on the side of the swinger 210 comes into contact with the placement surface 315a1. This allows the fixing member 314 to be reliably placed on the placement surface 315a1 of the placement area 315a. A plurality of (two) positioning protrusions or recesses (positioning protrusions 315a2 and 315a2 in such an example) (see FIG. 4C) are provided on the placement surface 315a1 of the placement area 315a. The rear surface 314b of the fixing member 314 includes positioning recesses or protrusions (positioning recesses 314c and 314c in such an example) (see FIG. 4D) corresponding to the plurality of (two) positioning protrusions or recesses (315a2, 315a2). This allows the fixing member 314 to be reliably positioned relative to the main body member 315. The placement area 315a includes a plurality of (two) holders 315a3 and 315a3 (see FIGS. 4C, 4D, and 5B). The placement area 315a and the holders 315a3 and 315a3 are integrally formed. The holders 315a3 and 315a3 detachably hold the fixing member 314 on the placement area 315a. The holders 315a3 and 315a3 restrict movement of the fixing member 314 towards the light emitting elements 31 to 31 in the optical axis direction N (one side N1). The holders 315a3 and 315a3 includes a locker 315a31 (see FIG. 5B) that locks the surface 314a of the fixing member 314.

The bent area 315b is bent at an acute angle (for example, less than 60 degrees, about 50 degrees in such an example) relative to the placement area 315a. The printed wiring board 312b is fixed to a surface 315b1 (inner surface) of the bent area 315b facing the placement area 315a. The input terminal 312b1 is provided at an entrance end of a space SP between the placement area 315a and the bent area 315b of the printed wiring board 312b, and the connector CN is connected toward the space SP.

The board guide 315c includes a curved area 315c1 that folds back the flexible circuit board 312a connected to the light-emitting element board 311 toward the space SP. The curved area 315c1 is curved to fold back at an angle of 180 degrees or more between the light-emitting element board 311 and the flexible circuit board 312a. A portion of the light-emitting element board 311 on the side of the flexible circuit board 312a and a portion of the flexible circuit board 312a on the side of the light-emitting element board 311 are bonded to the curved area 315c1 by the adhesive member E. This allows the curved area 315c1 to reliably fold the flexible circuit board 312a back into the space SP. The protective member 312d faces the light-emitting element board 311 and the portion of the flexible circuit board 312a corresponding to the curved area 315c1, and is curved along the curved area 315c1. As illustrated in FIGS. 4C and 4D, a fastening member SC1 (male screw) inserts through a through hole 312e1 of a retainer 312e and a through hole 312d1 of the protective member 312d on the one side L1 in the longitudinal direction L of the protective member 312d so that the protective member 312d is fastened to an area to be fastened 315e (female screw) of the main body member 315. This allows the end of the protective member 312d on the one side L1 in the longitudinal direction L to be fixed to the main body member 315.

The fastening member SC1 inserts through the through hole 312d1 of the protective member 312d on the other side L2 in the longitudinal direction L so that the protective member 312d is fastened to the area to be fastened 315e of the main body member 315. This allows the end of the protective member 312d on the other side L2 in the longitudinal direction L to be fixed to the main body member 315. In the printed wiring board 312b, the positioning hole 312b2 of the printed wiring board 312b is positioned by the positioning protrusion 315b2 of the bent area 315b on the other side L2 in the longitudinal direction L. In such a state, a fastening member SC2 (male screw) inserts through the through hole 315b3 of the bent area 315b and a through recess 312b3 of the printed wiring board 312b on the one side L1 in the longitudinal direction L so that the printed wiring board 312b is fastened to an area to be fastened 312e2 (female screw) of the retainer 312e. This allows the protective member 312d to be held in position at the bent area 315b.

The end of the flexible circuit board 312a on the side of the printed wiring board 312b disposed within the space SP is folded back at a corner between the placement area 315a and the bent area 315b and connected to the printed wiring board 312b.

The drive circuit element 312c is provided on the side of the placement area 315a in the flexible circuit board 312a. A recess 315a5 is provided on a facing surface 315a4 (inner surface) of the placement area 315a facing the bent area 315b to prevent interference with the drive circuit element 312c in the flexible circuit board 312a.

The main body member 315 includes a pair of side plates 315f and 315g (see FIGS. 4C and 4D) closing both ends of the space SP in the longitudinal direction L.

### Tilt Adjustment Mechanism

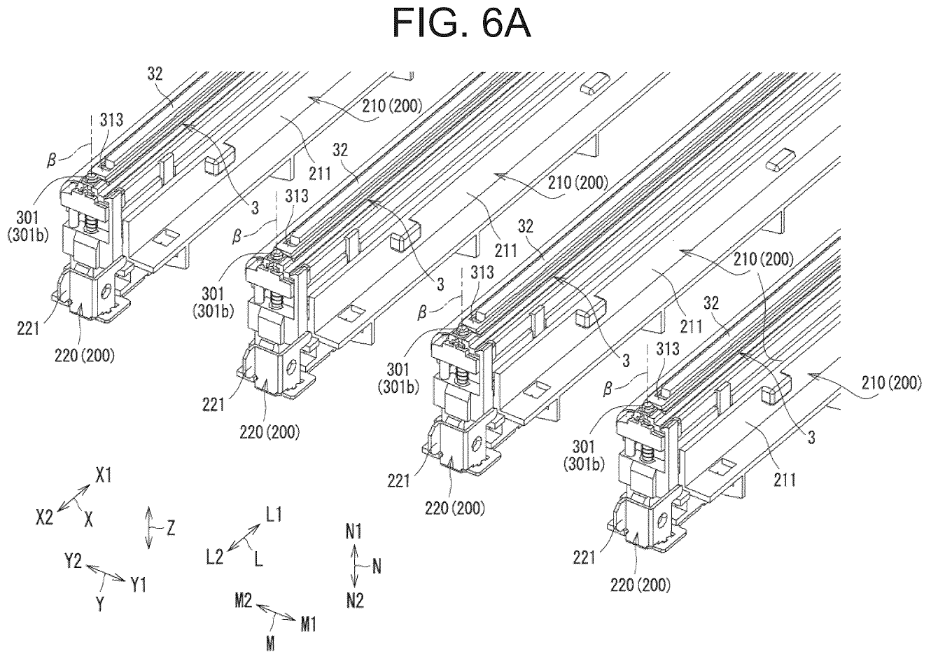

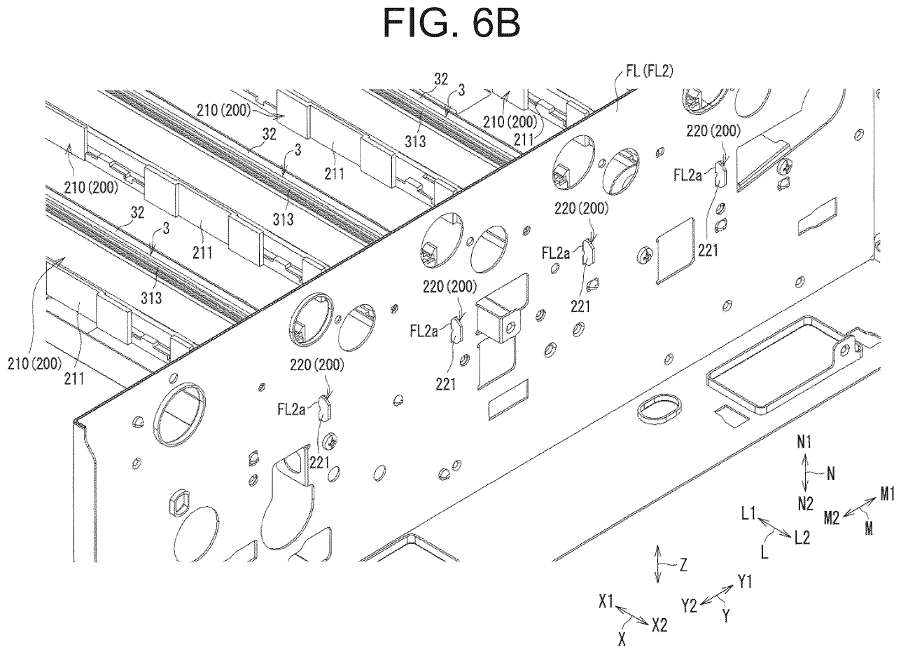

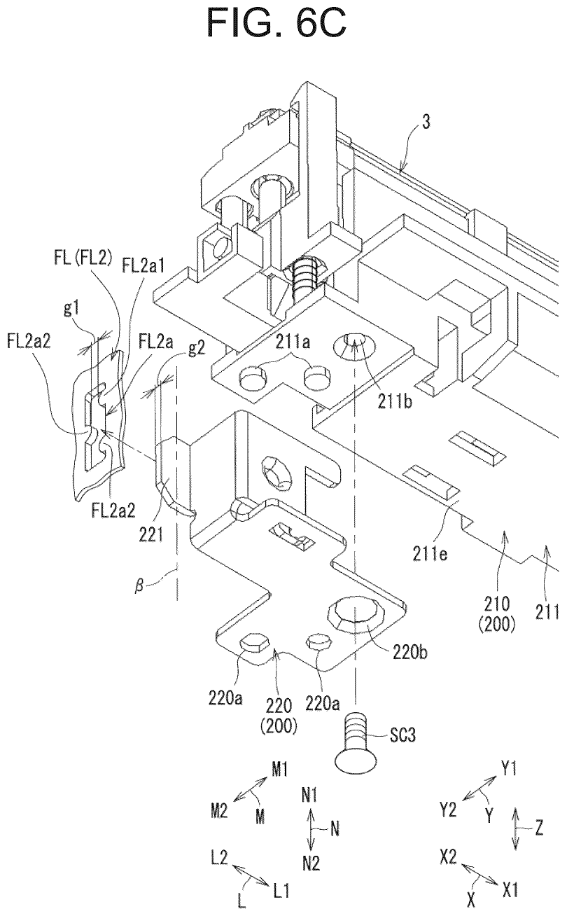

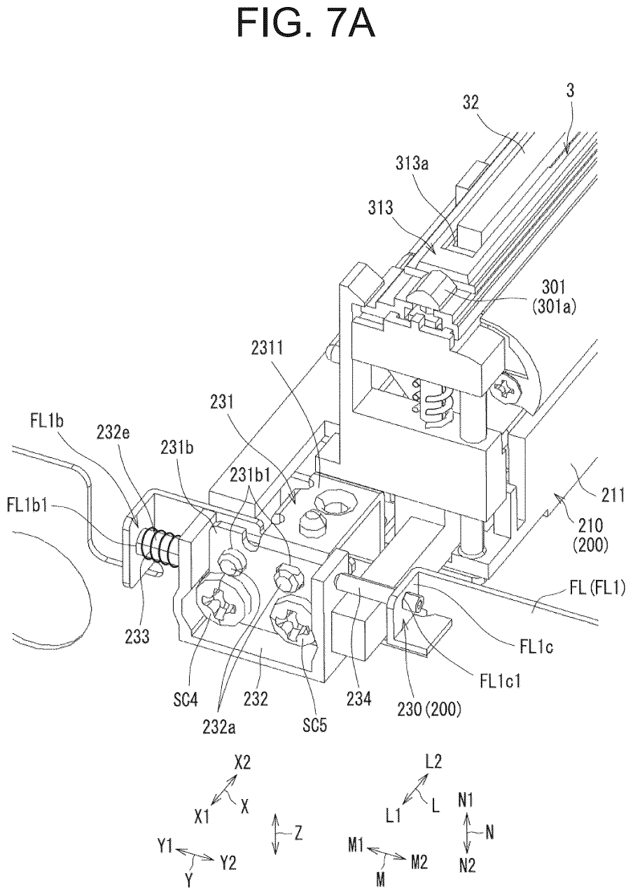

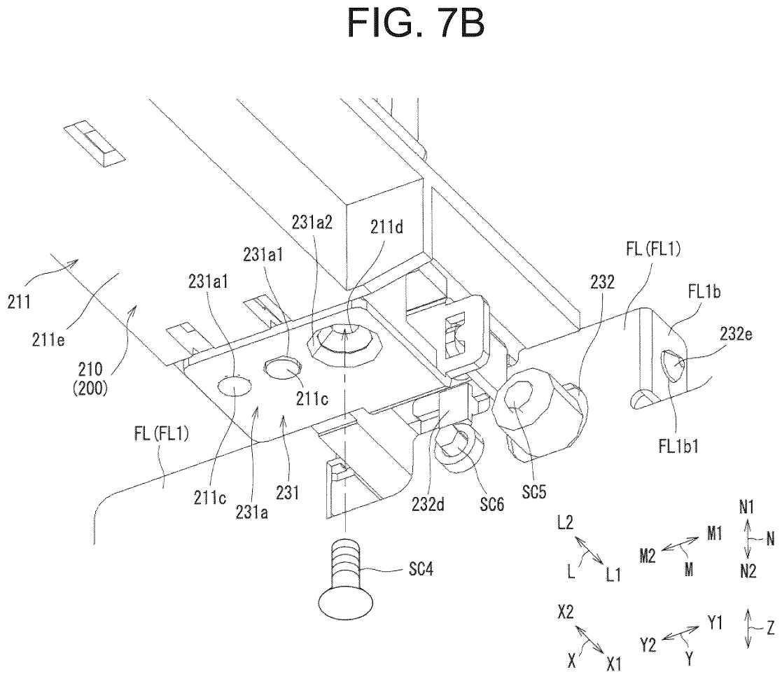

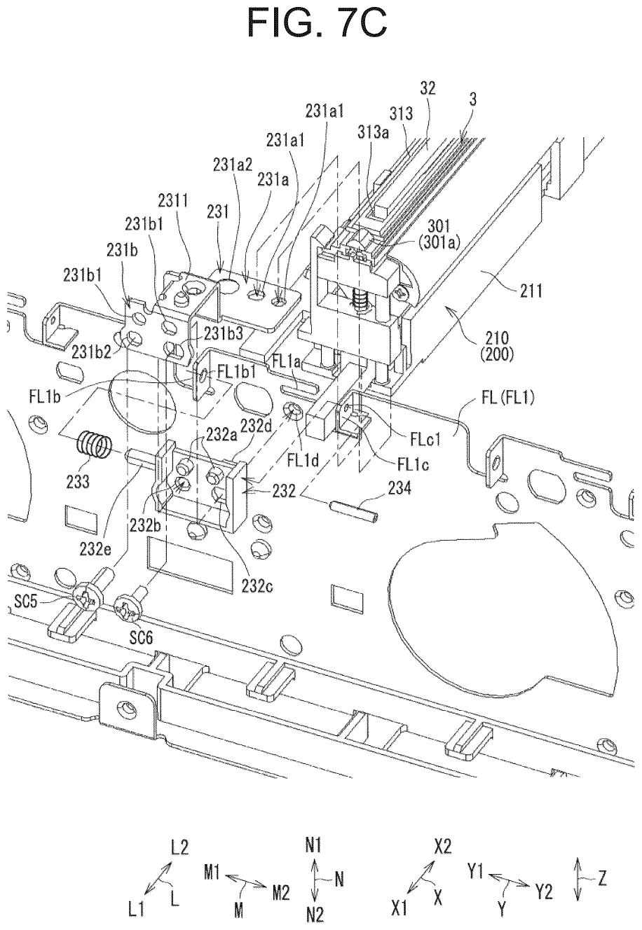

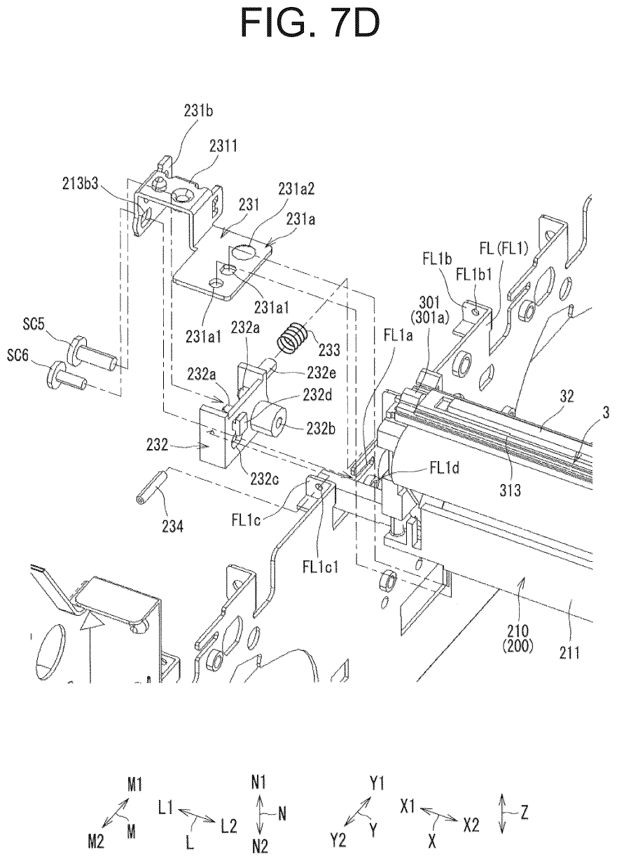

Next, an example of the tilt adjustment mechanism 200 will be described below with reference to FIGS. 6A to 7.

FIG. 6A is a perspective view of a swing supporter 220 provided in the swinger 210, as viewed obliquely from above on the back side X2. FIG. 6B is a perspective view illustrating a state in which the swing supporter 220 provided in the swinger 210 is inserted into a through hole FL2a in a main body frame FL2 on the back side X2, as viewed obliquely from above on the back side X2. FIG. 6C is an exploded perspective view of the swinger 210, the swing supporter 220, and the through hole FL2a in the main body frame FL2, as viewed obliquely from below on the back side X2. FIGS. 7A and 7B are perspective views of the tilt adjuster 230 provided on the main body frame FL1 on the front side X1, as viewed obliquely from above on the front side X1 and obliquely from below on the back side X2, respectively. FIGS. 7C and 7D are exploded perspective views of the tilt adjuster 230 as viewed obliquely from above on the front side X1 and the back side X2, respectively.

The tilt adjustment mechanism 200 includes the swinger 210, the swing supporter 220 (see FIGS. 6A and 6B), and the tilt adjuster 230 (see FIGS. 7A to 6D). The print head 3 is provided on the swinger 210. The swinger 210 is allowed to freely swing about the swing axis β by the swing supporter 220 provided on a swinger body 211, and a tilt about the swing axis β is adjusted by the tilt adjuster 230. The swing supporter 220 is fixed to an end of the swinger body 211 on the other side L2 (in such an example, the back side X2) in the longitudinal direction L. The main body frame FL (in such an example, the main body frame FL2 on the back side X2) (see FIG. 6B) of the image forming apparatus main body 101 (see FIG. 1) supports the swinger body 211 so that the swinger body 211 can freely swing around the swing axis β (see FIG. 6A).

In such an example, the main body frames FL1 and FL2 are supported at the centers in the rotation axis direction X by a main body frame FL3 aligned along the rotation axis direction X and the left-right direction Y. The swinger 210 is mounted on the main body frame FL3. The swing supporter 220 is a plate-shaped member extending in the optical axis direction N, as illustrated in FIGS. 6A and 6B. The swing supporter 220 includes a protrusion 221 protruding toward the other side L2 and extending in the optical axis direction N. The main frame FL2 on the back side X2 includes a through hole FL2a through which the protrusion 221 passes.

As illustrated in FIG. 6C, the through hole FL2a supports swinging of the swing supporter 220 around the swing axis β by point contact at one or more (three in such an example) points. More specifically, one or more protrusions FL2a1 to FL2a3 are provided on the edge of the through hole FL2a of at least one side (both sides in such an example) in the width direction M. In such an example, two protrusions FL2a1 and FL2a2 are provided at an edge of the through hole FL2a on one side M1 in the width direction M, and two protrusions FL2a1 and Fl2a2 are spaced apart in the up-down direction Z. One protrusion FL2a3 is provided on the edge of the through hole FL2a on the other side M2 in the width direction M between (specifically, at the center) the two protrusions FL2a1 and FL2a2 on the one side M1 provided in the up-down direction Z. A dimension g1 of the through hole FL2a in the width direction M (a dimension between the protrusions FL2a1 and FL2a2 on one side H1 and the protrusion FL2a3 on the other side in the width direction H) is larger than a dimension g2 of the protrusion 221 in the width direction M by a predetermined dimension to the extent that the swinger body 211 can swing. This allows the swinger body 211 to swing around the swing axis β.

The swing supporter 220 includes a plurality of (two) positioning holes 220a and 220a and a through hole 220b. Positioning protrusions 211a and 211a (see FIG. 6C) and an area to be fastened 211b (female screw) (see FIG. 6C) are provided on a rear surface 211e of the swinger body 211 opposite the print head 3. The positioning protrusions 211a and 211a are inserted into the plurality of positioning holes 220a and 220a of the swing supporter 220. The area to be fastened 211b is fastened by inserting a fastening member SC3 (male screw) (see FIG. 6C) through the through hole 220b of the swing supporter 220. This allows the swing supporter 220 to be fixed in position relative to the swinger body 211.

As illustrated in FIGS. 7A to 7D, the tilt adjuster 230 includes a coupling member 231, a moving member 232, a biasing member 233, and an adjustment member 234. The coupling member 231 couples the swinger body 211 of the swinger 210 and the moving member 232. The moving member 232 is provided movably on the one side M1 (left side Y1) and the other side M2 (right side Y2) in the width direction M relative to the main body frame FL1 on the front side of the image forming apparatus main body 101. The biasing member 233 biases the moving member 232 toward the other side M2 in the width direction M (in such an example, the upstream side in the rotation direction R of the photosensitive drum 1 (see FIG. 1)) relative to the front main body frame FL1 on the front side. The adjustment member 234 presses the moving member 232 toward the one side M1 in the width direction M (in such an example, the downstream side in the rotation direction R of the photosensitive drum 1) relative to the main body frame FL1 on the front side to adjust the position.

More specifically, the coupling member 231 is formed by stamping and bending a metal sheet, and includes a main body 2311, and a first area to be fixed 231a and a second area to be fixed 231b coupled to the main body 2311. The first area to be fixed 231a is fixed to the swinger body 211 of the swinger 210. The second area to be fixed 231b is fixed to the moving member 232.

The first area to be fixed 231a includes a plurality of (two) positioning holes 231a1 and 231a1 and a through hole 231a2. Protrusions 211c and 211c (see FIG. 7B) and the area to be fastened 211d (female screw) (see FIG. 7B) are provided on the rear surface 211e of the swinger body 211 opposite the print head 3. The protrusions 211c and 211c are inserted into the plurality of positioning holes 231a1 and 231a1 of the first area to be fixed 231a. The area to be fastened 211d is fastened by inserting the fastening member SC4 (male screw) (see FIG. 7B) through the through hole 231a2 of the first area to be fixed 231a. This allows the coupling member 231 to be fixed in position relative to the swinger 210.

The second area to be fixed 231b includes a plurality of (two) positioning holes 231b1 and 231b1, a through hole 231b2, and a long through hole 231b3. The moving member 232 includes positioning protrusions 232a and 232a, an area to be fastened 232b (female screw) (see FIGS. 7B and 7D), and a long through hole 232c (see FIGS. 7B and 7D). The positioning protrusions 232a and 232a are inserted into the plurality of positioning holes 231b1 and 231b1 of the second area to be fixed 231b. The area to be fastened 232b is fastened by inserting the fastening member SC5 (male screw) (see FIG. 7B) through the through hole 231b2 of the second area to be fixed 231b. This allows the coupling member 231 to be fixed in position relative to the moving member 232. The long through hole 231b3 and the long through hole 232c are provided in the second area to be fixed 231b and the moving member 232, respectively, such that the long through hole 231b3 and the long through hole 232c are aligned with each other.

A first guide 232d (FIGS. 7B, 7C, and 7D) having a T-shape in cross section as viewed from the width direction M is provided on the side of the moving member 232 opposite to the positioning protrusions 232a and 232a. The main body frame FL1 on the front side includes a first slider FL1a (see FIGS. 7C and 7D). The first slider FL1a is a slit portion along the width direction M, and the first guide 232d is inserted from the other side M2 to the one side M1 in the width direction M. This allows the moving member 232 to be freely movable in the width direction M. At an end of the moving member 232 on the one side M1 in the width direction M, a rod-shaped (cylindrical) second guide 232e (see FIGS. 7A, 7C, and 7D) is provided along the width direction M. A first frame FL1b along the rotation axis direction X and the up-down direction Z of the main frame FL1 on the front side includes a second slider FL1b1. The second slider FL1b1 is a through hole along the width direction M, and the second guide 232e is inserted therethrough. The biasing member 233 is a coil spring, and is inserted into the second guide 232e between the first frame FL1b and the moving member 232.

An area to be fastened FL1c1 (female screw) is provided on the second frame FL1c aligned along the rotation axis direction X and the up-down direction Z of the main frame FL1 on the front side. The adjustment member 234 is an adjustable fastener (a headless male screw, a so-called insect screw) along the width direction M. The area to be fastened FL1c1 is fastened to the adjustment member 234. Thus, while the adjustment member 234 is biased toward the other side M2 in the width direction M by the biasing member 233, an operator can rotate the adjustment member 234 with a tool such as a screwdriver to move the adjustment member 234 to the one side M1 or the other side M2 in the width direction M, to adjust a tilt of the print head 3 fixed to the moving member 232 about the swing axis β.

The main frame FL1 on the front side includes an area to be fastened FL1d (female screw) (see FIGS. 7C and 7D). The area to be fastened FL1d is fastened by inserting a fastening member SC6 (male screw) (see FIGS. 7C and 7D) through the long through hole 231b3 of the second area to be fixed 231b and the long through hole 232c of the moving member 232. This allows the print head 3 to fix to the body frame FL1 on the front side after adjusting a tilt of the print head 3 around the swing axis β.

### Positioning Mechanism

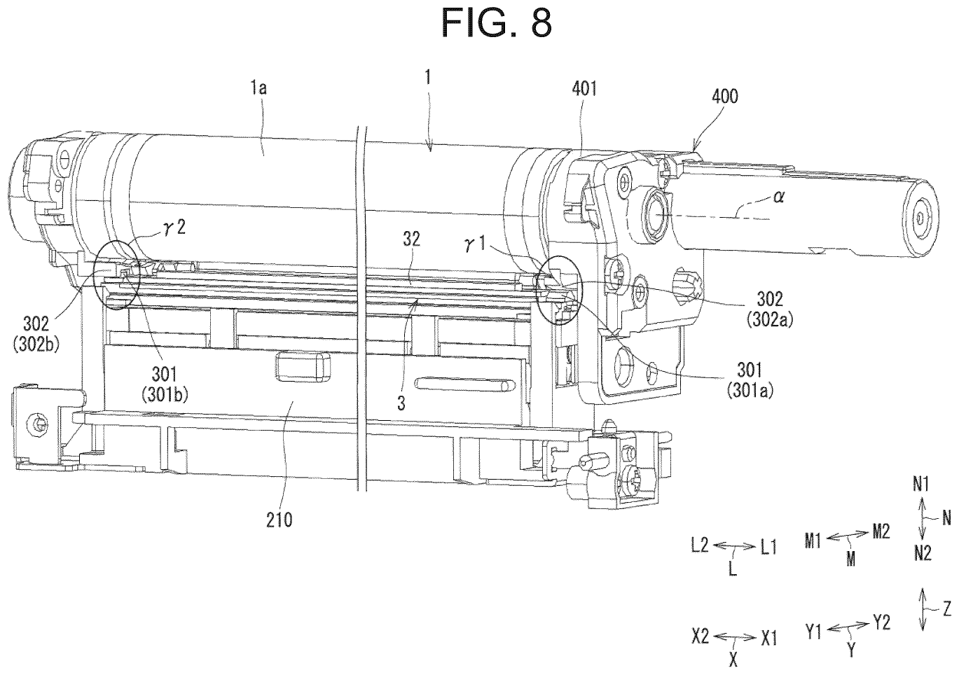

Next, an example of a positioning mechanism 300 will be described below with reference to FIGS. 8 to 12.

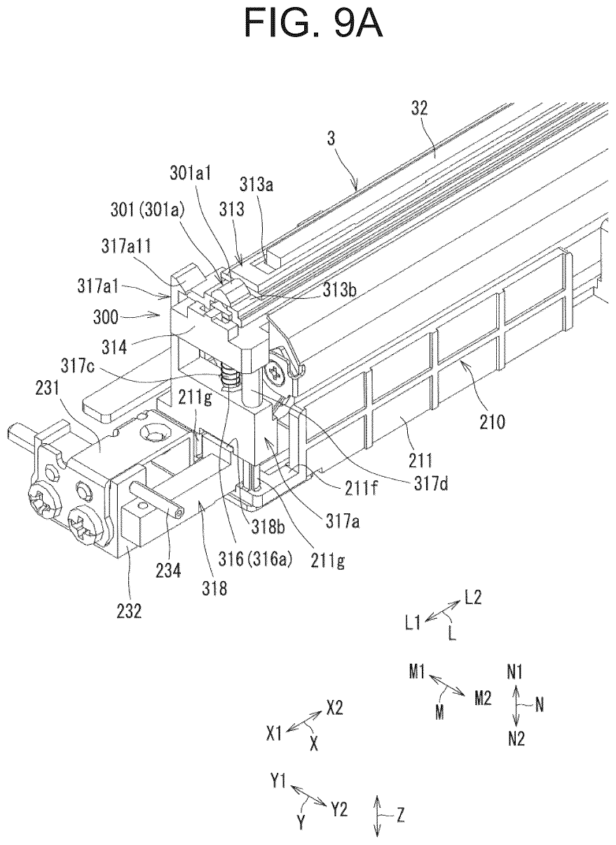

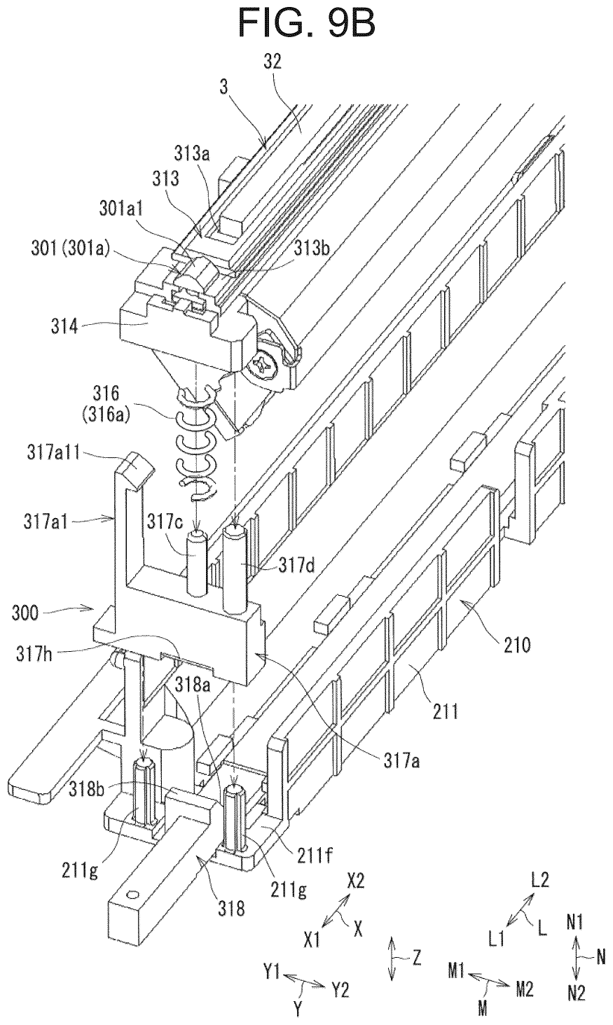

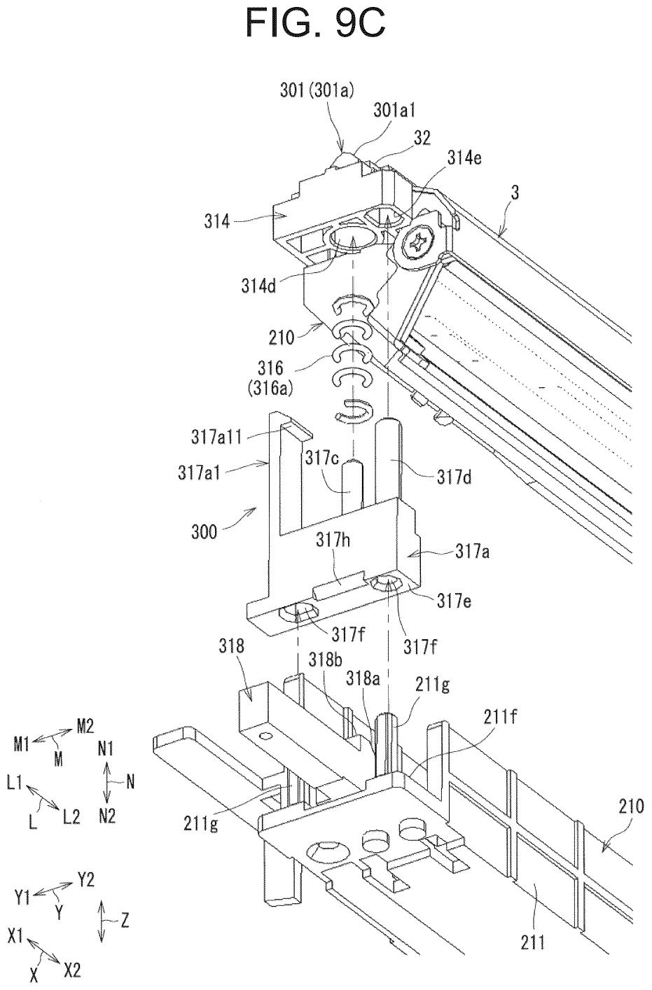

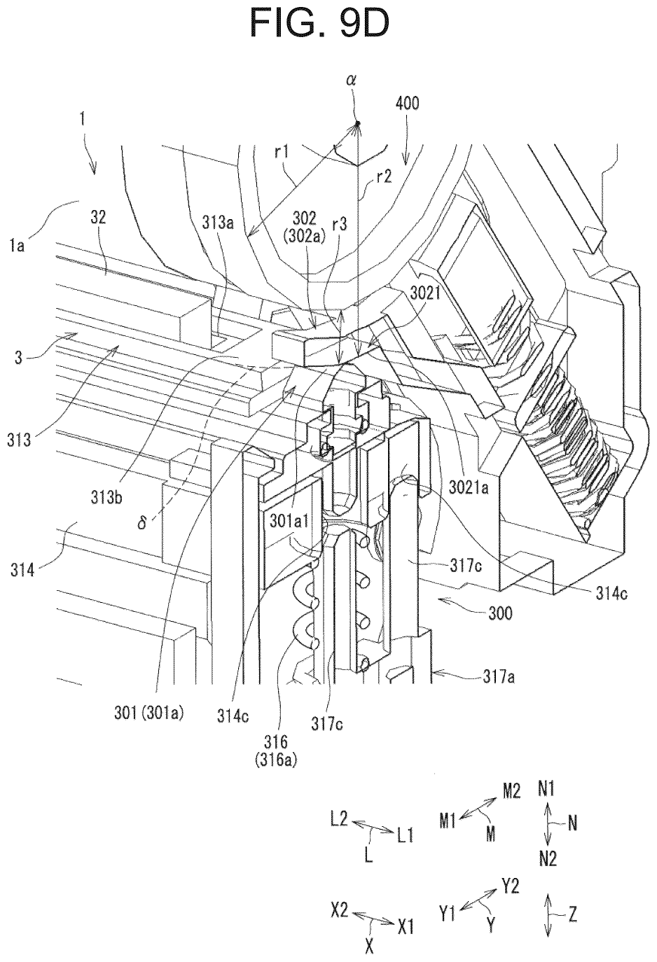

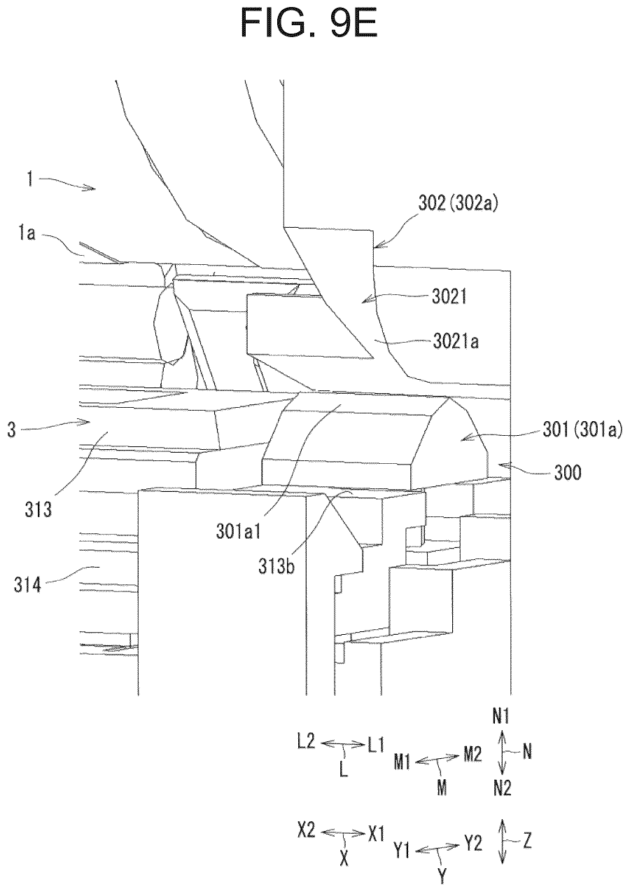

FIG. 8 is a perspective view of a photosensitive unit 400, the print head 3, and the swinger 210, as viewed from above on the left side. FIG. 9A is a perspective view of a portion of a positioner 301a on the one side L1 of the swinger 210 including the print head 3, as viewed obliquely from above. FIGS. 9B and 9C are exploded perspective views of the print head 3 and the swinger 210 illustrated in FIG. 9A, as viewed obliquely from above and below, respectively. In FIGS. 9B and 9C, the coupling member 231, the moving member 232, and the adjustment member 234 are omitted in the figures. FIG. 9D is a cross-sectional perspective view of the positioner 301a and the area to be positioned 302a on the one side L1 illustrated in FIG. 8, as viewed obliquely from above. FIG. 9E is an enlarged view of the positioner 301a and the area to be positioned 302a on the one side L1 in a γ1 portion illustrated in FIG. 8.

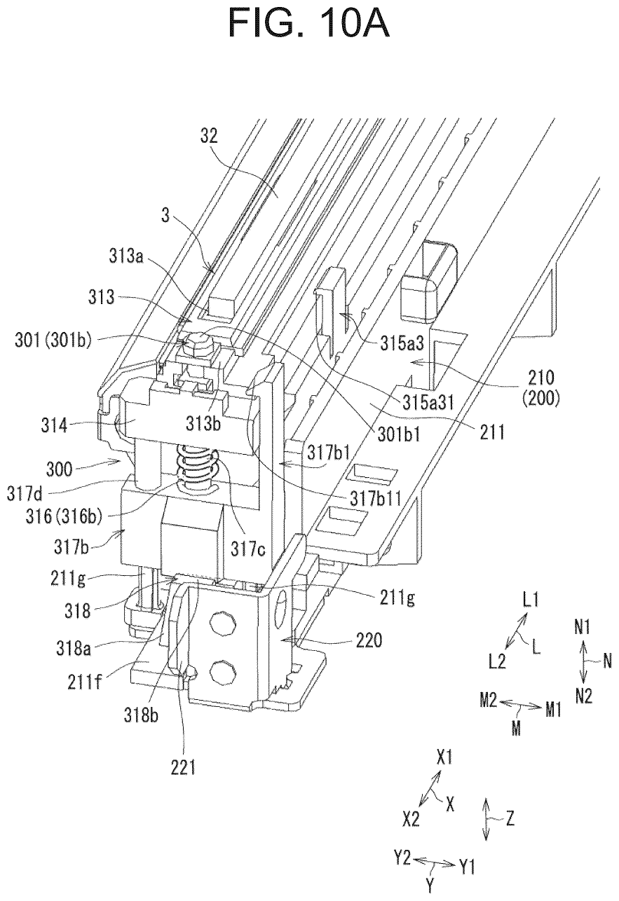

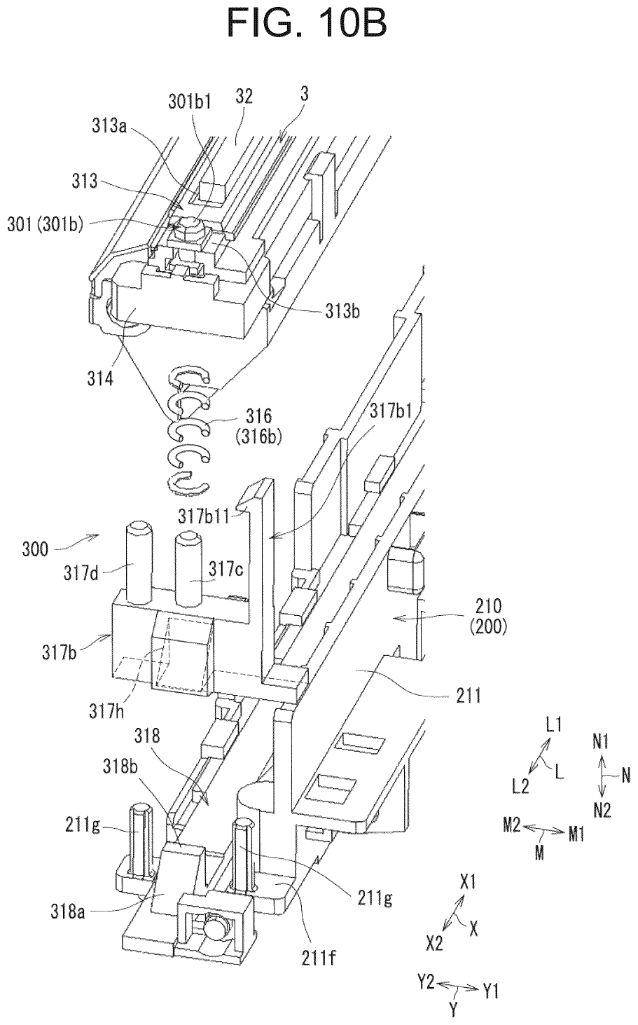

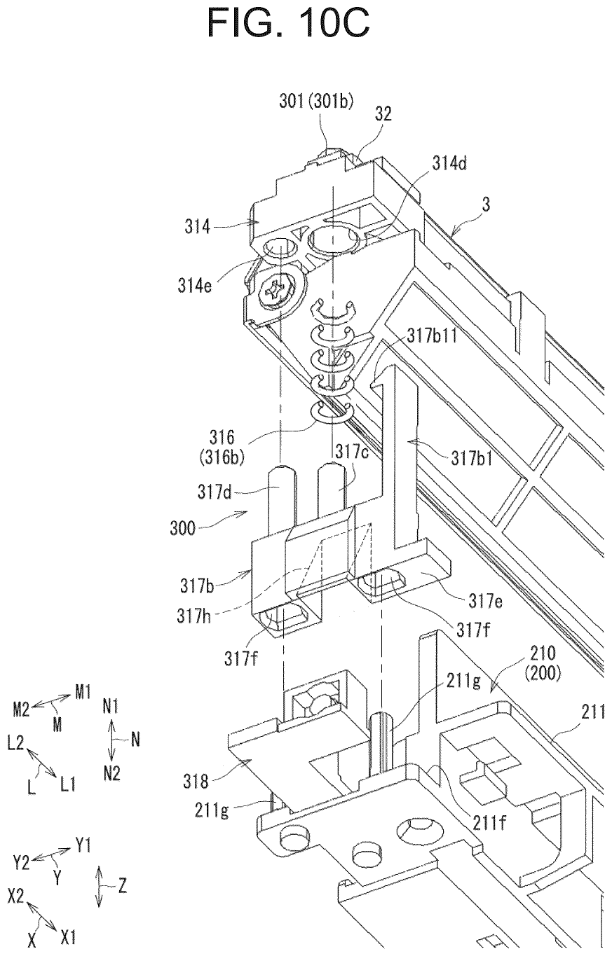

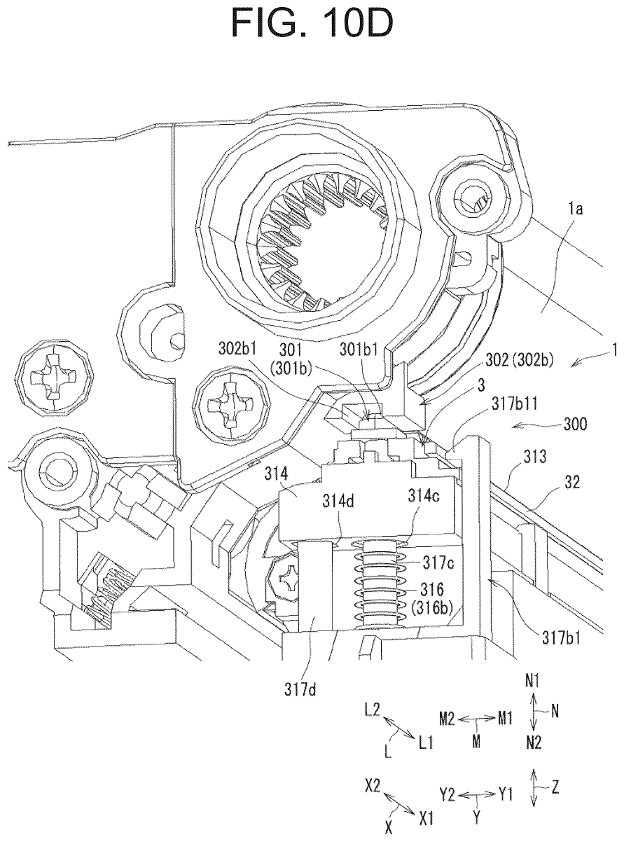

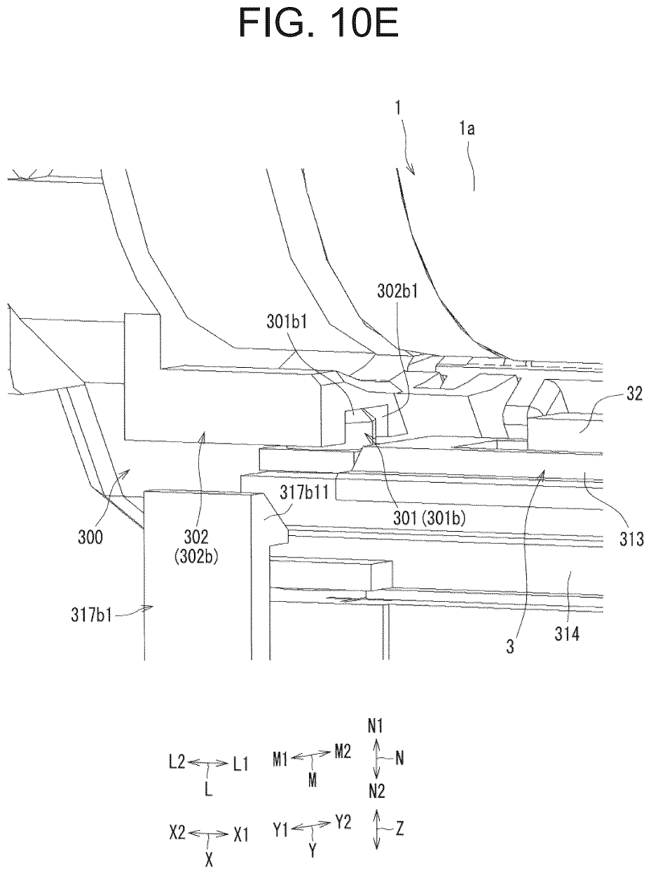

FIG. 10A is a perspective view of a portion of a positioner 301b on the other side L2 in the swinger 210 including the print head 3, as viewed obliquely from above. FIGS. 10B and 10C are exploded perspective views of the print head 3 and the swinger 210 illustrated in FIG. 10A, as viewed obliquely from above and below, respectively. It is noted that the swing supporter 220 is omitted in FIGS. 10B and 10C. FIG. 10D is a cross-sectional perspective view of the positioner 301b and the area to be positioned 302b on the other side L2 illustrated in FIG. 8, as viewed obliquely from below. FIG. 10E is an enlarged view of the positioner 301b and the area to be positioned 302b on the other side L2 in a γ2 portion illustrated in FIG. 8.

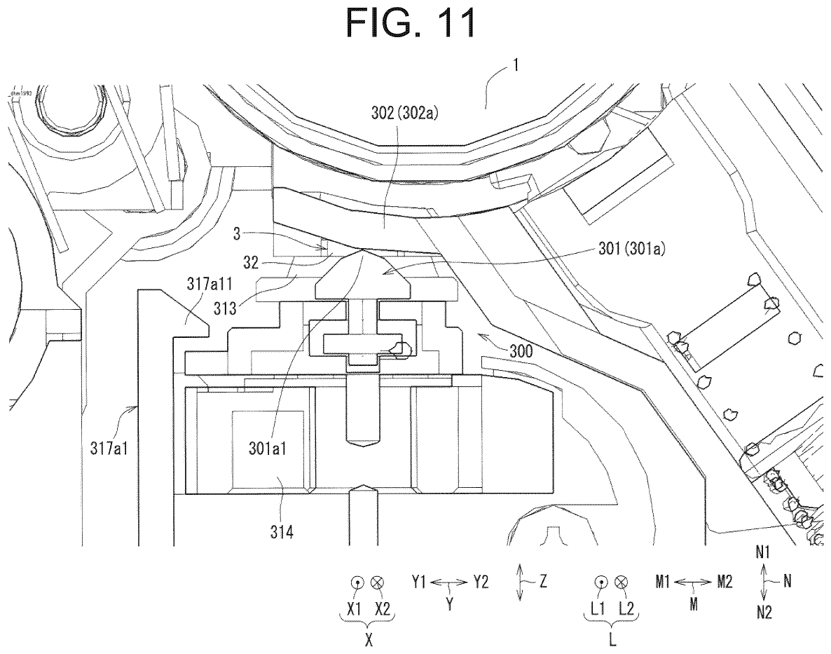

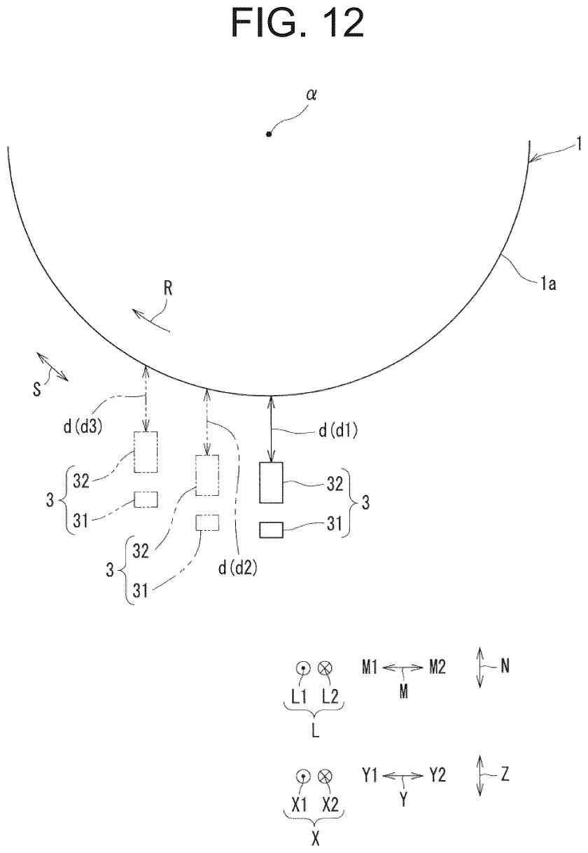

FIG. 11 is a cross-sectional view illustrating the positioner 301a on the one side L1 abutting against the area to be positioned 302b on the one side L1. FIG. 12 is a front view for explaining how the distance d between the print head 3 and the photosensitive drum 1 is maintained constant regardless of the tilt of the print head 3 around the swing axis β.

The image forming apparatus 100 further includes the positioning mechanism 300 (an example of a positioning mechanism). The positioning mechanism 300 positions the print head 3 relative to the photosensitive drum 1 to maintain a constant distance d (focal length) between the print head 3 and the photosensitive drum 1 regardless of the tilt of the print head 3 around the swing axis β caused by the tilt adjustment mechanism 200. Here, “maintain a constant distance d” has a concept including not only maintaining the focal length of the print head 3 constant, but alto keeping the focal length of the print head 3 within a tolerance (depth of focus) (for example, ±0.1 mm).

In the image forming apparatus 100 according to the present embodiment, as illustrated in FIG. 12, in adjusting the tilt of the print head 3 around the swing axis β, the print head 3 moves along a circumferential direction S of the photosensitive drum 1, so that the distance d (d1, d2, d3) between the photosensitive drum 1 and the print head 3 can be kept constant (d1=d2=d3) depending on the position of the print head 3 in the circumferential direction S. This is more effective as the diameter (curvature) of the photosensitive drum 1 is smaller as the image forming apparatus 100 is more compact.

Thus, according to the present embodiment, regardless of the tilt of the print head 3 around the swing axis β caused by the tilt adjustment mechanism 200, the positioning mechanism 300 can maintain a constant distance d between the print head 3 and the photosensitive drum 1. This allows the distance d between the print head 3 and the photosensitive drum 1 to be constant, regardless of the tilt of the print head 3 around the swing axis β caused by the tilt adjustment mechanism 200.

### First Embodiment

In the present embodiment, the positioning mechanism 300 includes a positioner 301 (301a, 301b) and an area to be positioned 302 (302a, 302b). The positioner 301 (301a, 301b) is provided in the print head 3 to determine a position of the print head 3 relative to the photosensitive drum 1. The area to be positioned 302 (302a, 302b) is provided on a main body side member (in such an example, a housing 401 of the photosensitive drum 1 (see FIG. 8)) which is a member on the main body side of the image forming apparatus 100 to abut against the positioner 301 (301a, 301b). The area to be positioned 302 (in such an example, the area to be positioned 302a on the one side L1) includes an arc-shaped area 3021 that is concentric with the center of rotation (rotation axis α) of the photosensitive drum 1 and has a radius larger than a radius r1 of the photosensitive drum 1 (see FIG. 9D). More specifically, the area to be positioned 302 (302a) includes the arc-shaped area 3021 formed along a virtual arc δ having an arc radius r2 (see FIG. 9D) larger than the radius r1 of the photosensitive drum 1, with the arc center being concentric with the center of rotation (α) of the photosensitive drum 1. That is, the arc-shaped area 3021 has an arc radius r2 (r1+r3) obtained by adding a predetermined distance r3 (see FIG. 9D) to the radius r1 of the photosensitive drum. The arc-shaped area 3021 has an abutment surface 3021a that abuts against the positioner 301 (301a).

In such a configuration, even when the print head 3 swings around the swing axis β by the tilt adjustment mechanism 200, the positioner 301 (301a, 301b) abuts against the abutment surface 3021a (see FIGS. 9D and 9E) of the arc-shaped area 3021 of the area to be positioned 302, so that the print head 3 can be positioned to maintain a constant distance d between the print head 3 and the photosensitive drum 1. A configuration can be easily realized in which the distance d (see FIG. 12) between the print head 3 and the photosensitive drum 1 is maintained constant by abutting the positioner 301 (301a, 301b) against the area to be positioned 302 (302a, 302b).

### First Embodiment—1

In the present embodiment, the print head 3 includes the lens holding member 313 and the fixing member 314 (see FIGS. 5B, 5C, and the like). The lens holding member 313 holds the lens array 32. The fixing member 314 fixes the light-emitting element board 311 or the panel. The positioner 301 (301a, 301b) are provided in the lens holding member 313.

In such a configuration, if the positioner 301 (301a, 301b) is provided in the lens holding member 313 that holds lens array 32, the position of print head 3 including the lens array 32 relative to the photosensitive drum 1 can be determined with high accuracy. Furthermore, there is no need to prepare a separate member for providing the positioner 301 (301a, 301b), which makes it possible to realize a smaller and less costly image forming apparatus 100.

### First Embodiment—2

In the present embodiment, the positioning mechanism 300 further includes the biasing member 316 (316a, 316b) that biases the positioner 301 (301a, 301b) toward a main body side member (in such an example, the housing 401 of the photosensitive drum 1). The area to be positioned 302 (302a, 302b) is biased by the biasing member 316 (316a, 316b) to abut against the positioner 301 (301a, 301b). Here, the plurality of holders 315a3 and 315a3 in the lens holding member 313 including the positioner 301 (301a, 301b) have an effect for restricting excessive movement of the fixing member 314 towards the main body side member (401) by the biasing member 316 (316a, 316b).

In such a configuration, the biasing member 316 (316a, 316b) enables the positioner 301 (301a, 301b) reliably abutting against the area to be positioned 302 (302a, 302b), and as a result, the distance d between the print head 3 and the photosensitive drum 1 can be stably maintained.

In such an example, the positioner 301 includes a pair of positioners 301a and 301b, one on each side of the print head 3 in the longitudinal direction L. The area to be positioned 302 includes a pair of areas to be positioned 302a and 302b corresponding to the pair of positioners 301a and 301b, respectively. The pair of positioners 301a and 301b are provided on both ends in the longitudinal direction L (outside the lens array 32) in a surface 313b of the lens holding member 313 on a side of the lens array 32. Further, the biasing member 316 includes a pair of biasing members 316a and 316b.

The positioning mechanism 300 further includes a pair of lifting members 317a and 317b. The pair of lifting members 317a and 317b are provided at both ends of the swinger body 211 (outside the print head 3) in the longitudinal direction L to be freely movable in the optical axis direction N. The print head 3 is provided to be freely movable in the optical axis direction N relative to the pair of lifting members 317a and 317b. The print head 3 is biased toward the photosensitive drum 1 by the pair of biasing members 316a and 316b arranged between the pair of lifting members 317a and 317b and the print head 3, with movement to the one side N1 in the optical axis direction N restricted by regulators 317a1 and 317b1.

More specifically, an insertion protrusion (317c, 317d), (317c, 317d) is provided on a surface 317g of the pair of lifting members 317a and 317b on a side of the swinger 210. The insertion protrusion (317c, 317d), (317c, 317d) extends toward a side of the print head 3 (the one side N1) in the optical axis direction N. The rear surface 314b of the fixing member 314 includes an insertion recess (314d, 314e), (314d, 314e) (see FIGS. 9C and 10C) into which the insertion protrusion (317c, 317d), (317c, 317d) is inserted, respectively. This allows the print head 3 to be restricted in the longitudinal direction L and width direction M relative to the pair of lifting members 317a and 317b while allowing the print head 3 to be freely moved in the optical axis direction N relative to the pair of lifting members 317a and 317b. The pair of biasing members 316a and 316b are coil springs into which the insertion protrusions 317c and 317c on the one side M1 is inserted between the fixing member 314 and the pair of lifting members 317a and 317b. This allows the print head 3 to be biased toward the photosensitive drum 1 for the pair of lifting members 317a and 317b.

The pair of lifting members 317a and 317b include the regulators 317a1 and 317b1. The pair of lifting members 317a and 317b and the regulators 317a1 and 317b1 are integrally formed. The regulators 317a1 and 317b1 detachably restrict movement of the fixing member 314 of the print head 3 to the one side N1 in the optical axis direction N. The regulators 317a1 and 317b1 include lockers 317a11 and 317b11 that lock the surface 314a of the fixing member 314.

The photosensitive drum 1 and the print head 3 are close to each other, and thus, when an operator replaces the photosensitive drum 1, the photosensitive drum 1 may come into contact with the print head 3 in inserting or removing the photosensitive drum 1 in the rotation axis direction X relative to the image forming apparatus main body 101.

In this regard, the positioning mechanism 300 further includes an actuating member 318 that raises and lowers the pair of lifting members 317a and 317b. The actuating member 318 is movable in the longitudinal direction L relative to the swinger body 211, and movement in the longitudinal direction L raises and lowers the pair of lifting members 317a and 317b.

More specifically, the surface 211f of the swinger body 211 on the side of the print head 3 includes an insertion protrusion (211g, 211g), (211g, 211g) erected at both ends in the longitudinal direction L. The insertion protrusion (211g, 211g), (211g, 211g) extends toward the one side N1 in the optical axis direction N. The rear surface 317e of the pair of lifting members 317a and 317b on a side of the swinger 210 includes an insertion recess (317f, 317f), (317f, 317f) (see FIGS. 9C and 10C) into which the insertion protrusion (211g, 211g), (211g, 211g) is respectively inserted. This allows the pair of lifting members 317a and 317b to be restricted in the longitudinal direction L and width direction M relative to the swinger body 211 while allowing the pair of lifting members 317a and 317b to be freely movable in the optical axis direction N relative to the swinger body 211.

The actuating member 318 is provided between the pair of lifting members 317a and 317b and the surface 211f of the swinger body 211. The actuating member 318 includes a plurality of (two) tilted surfaces 318a and 318a and top surfaces 318b and 318b. The tilted surfaces 318a and 318a are tilted to slide against the pair of lifting members 317a and 317b as the actuating member 318 moves to either one side L1 or the other side L2 in the longitudinal direction L, and as a result, the pair of lifting members 317a and 317b is tilted to be moved away from and towards the photosensitive drum 1, respectively. The pair of lifting members 317a and 317b include tilted surfaces 317h and 317h (see FIGS. 9B and 10B). The tilted surfaces 317h and 317h are provided at locations corresponding to the tilted surfaces 318a and 318a in the actuating member 318 of the pair of lifting members 317a and 317b, and are tilted along the tilted surfaces 318a and 318a.

In the configuration described above, when an operator moves the actuating member 318 from a first position where the pair of lifting members 317a and 317b are farthest from the photosensitive drum 1 to the other side L2 in the longitudinal direction L, the tilted surfaces 318a and 318a slide against the tilted surfaces 317h and 317h of the pair of lifting members 317a and 317b. At this time, the biasing forces of the biasing members 316a and 316b act on the pair of lifting members 317a and 317b, causing the pair of lifting members 317a and 317b to approach the photosensitive drum 1 (rise). When the actuating member 318 moves further toward the other side L2 in the longitudinal direction L and the top surfaces 318b and 318b contact the rear surfaces 317e of the pair of lifting members 317a and 317b, the pair of lifting members 317a and 317b are maintained in a second position closest to the photosensitive drum 1. This brings the print head 3 close to the photosensitive drum 1 at a predetermined distance d to make the print head 3 ready for image formation.

On the other hand, when the operator moves the actuating member 318 from the second position of the pair of lifting members 317a and 317b to the one side L1 in the longitudinal direction L, the top surfaces 318b and 318b of the actuating member 318 move away from the rear surfaces 317e of the pair of lifting members 317a and 317b, and the tilted surfaces 318a and 318a slide against the tilted surfaces 317h and 317h of the pair of lifting members 317a and 317b. At this time, the biasing forces applied by the biasing members 316a and 316b to the pair of lifting members 317a and 317b are released, and the pair of lifting members 317a and 317b move away from the photosensitive drum 1 (descend). When the actuating member 318 moves further toward the one side L1 in the longitudinal direction L, the pair of lifting members 317a and 317b return to the first position. This makes it possible to prevent the photosensitive drum 1 from coming into contact with the print head 3 when the operator replaces the photosensitive drum 1.

### First Embodiment—3

In the present embodiment, the positioner 301a on the one side L1 (the front side X1 in such an example) of the pair of positioners 301a and 301b includes a convex area 301a1 extending in the longitudinal direction L. Of the pair of areas to be positioned 302a and 302b, the area to be positioned 302a on the one side L1 corresponding to the positioner 301a on the one side L1 includes an arc-shaped area 3021. The arc-shaped area 3021 includes an abutment surface 3021a abutting against the convex area 301a1 of the positioner 301a on the one side L1. In such an example, the convex area 301a1 has a mountain-like shape as viewed in cross section from the rotation axis direction X.

In such a configuration, the convex area 301a1 abutting against the arc-shaped area 3021 extends in the longitudinal direction L, so that the convex area 301a1 can be brought into stable and reliable abutment against the arc-shaped area 3021.

### First Embodiment—4

In the present embodiment, the positioner 301b on the other side L2 (in such an example, the back side X2) of the pair of positioners 301a and 301b includes a swing shaft 301b1 rotating about the swing axis β (see FIGS. 3 and 6A). The print head 3 is pivotable about the swing shaft 301b1. Of the pair of areas to be positioned 302a and 302b, the area to be positioned 302b on the other side L2 corresponding to the positioner 301b on the other side L2 includes a concave area 302b1 (groove) extending in the longitudinal direction L (see FIGS. 10D and 10E). The concave area 302b1 fittingly receives the swing shaft 301b1 in the positioner 301b on the other side L2.

In such a configuration, the concave area 302b1 in the area to be positioned 302b on the other side L2 fittingly receives the swing shaft 301b1 in the positioner 301b on the other side L2 to allow some leeway in a mounting position of the print head 3 to the main body side member (401) in the longitudinal direction L. Even if the print head 3 deviates slightly in the longitudinal direction L from a reference position relative to the main body side member (401) within an allowable range, the deviation of the image in the longitudinal direction L can ultimately be corrected in image processing.

The positioner 301 is the pair of positioners 301a and 301b, one on each side of the print head 3 in the longitudinal direction L. The area to be positioned 302 includes a pair of areas to be positioned 302a and 302b corresponding to the pair of positioners 301a and 301b, respectively. This allows the pair of positioners 301a and 301b to more reliably abut against the areas to be positioned 302a and 302b by the biasing members 316a and 316b to make it possible to keep the distance d between the print head 3 and the photosensitive drum 1 constant in an even more stable manner.

### First Embodiment—5

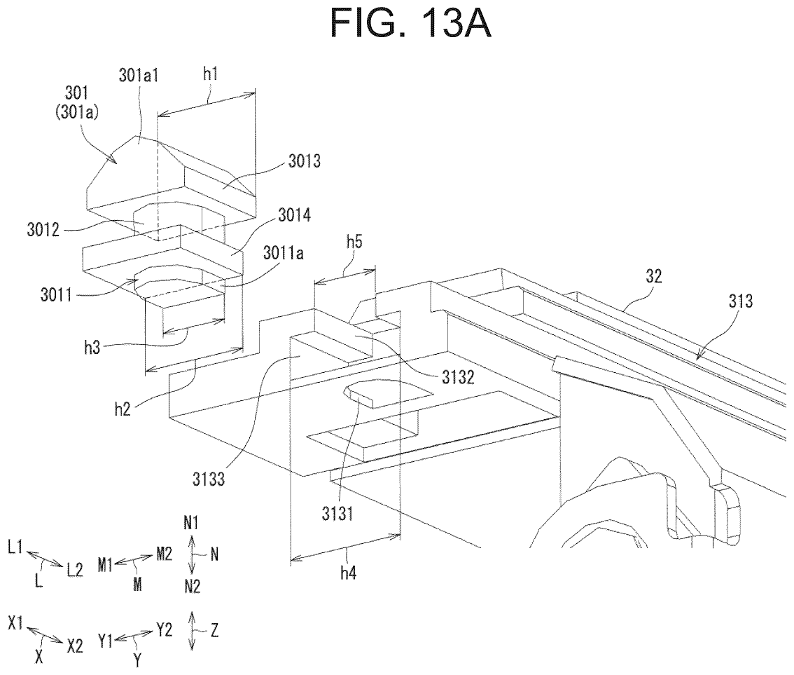

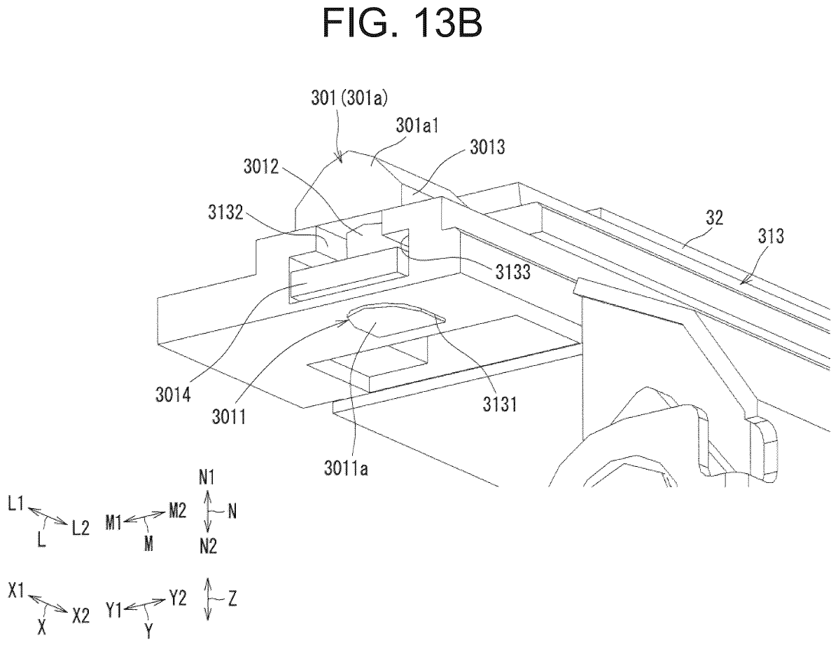

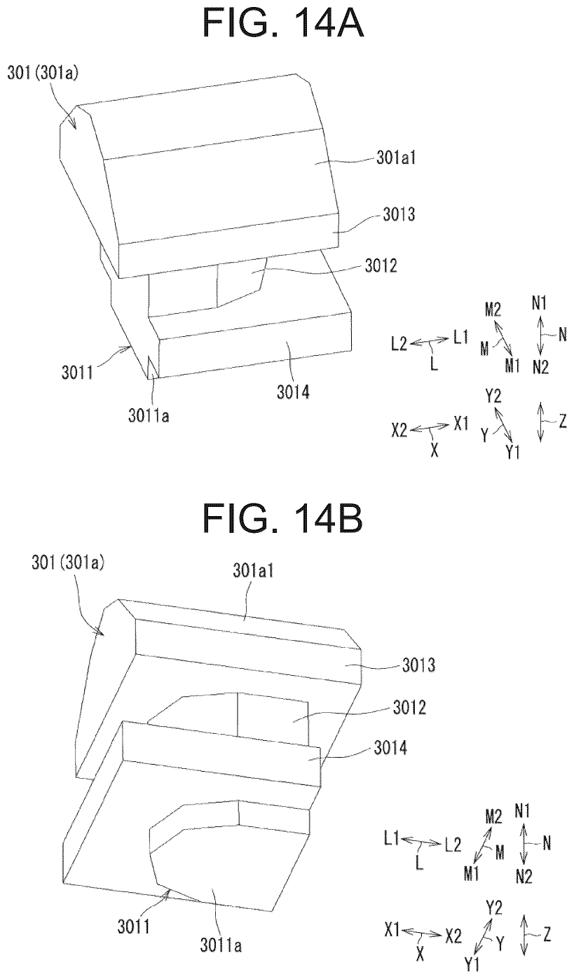

FIG. 13A is an exploded perspective view of the positioner 301a on the one side L1 and the lens holding member 313 as viewed obliquely from below. FIG. 13B is a perspective view illustrating the positioner 301a on the one side L1 attached to the lens holding member 313 as viewed obliquely from below. FIG. 14A is a perspective view of the positioner 301a on the one side L as viewed from above on the back side X2. FIG. 14B is a perspective view of the positioner 301a on the one side L1 as viewed from below on the front side X1.

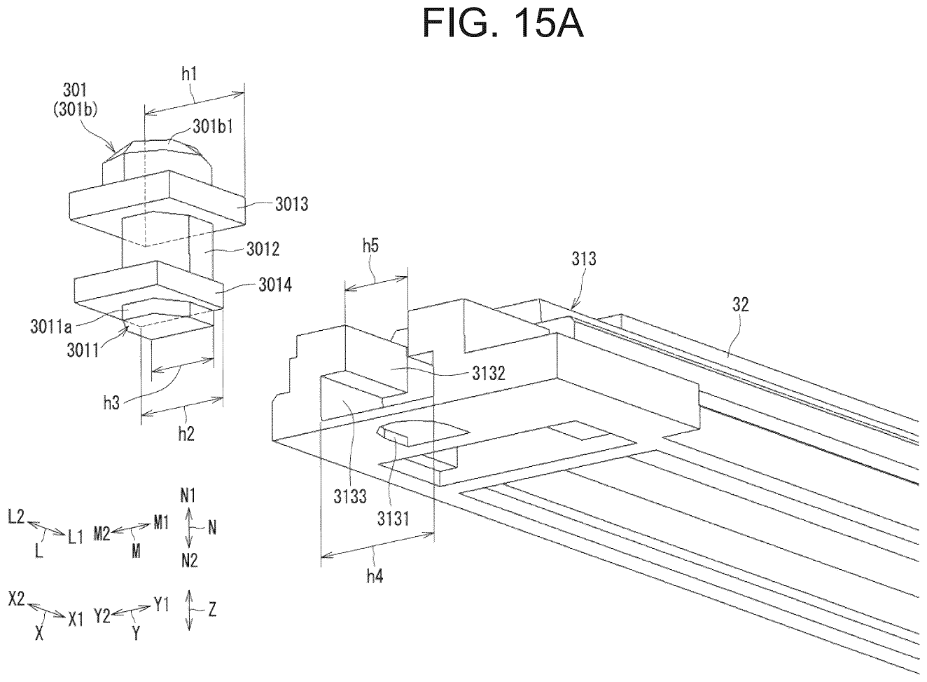

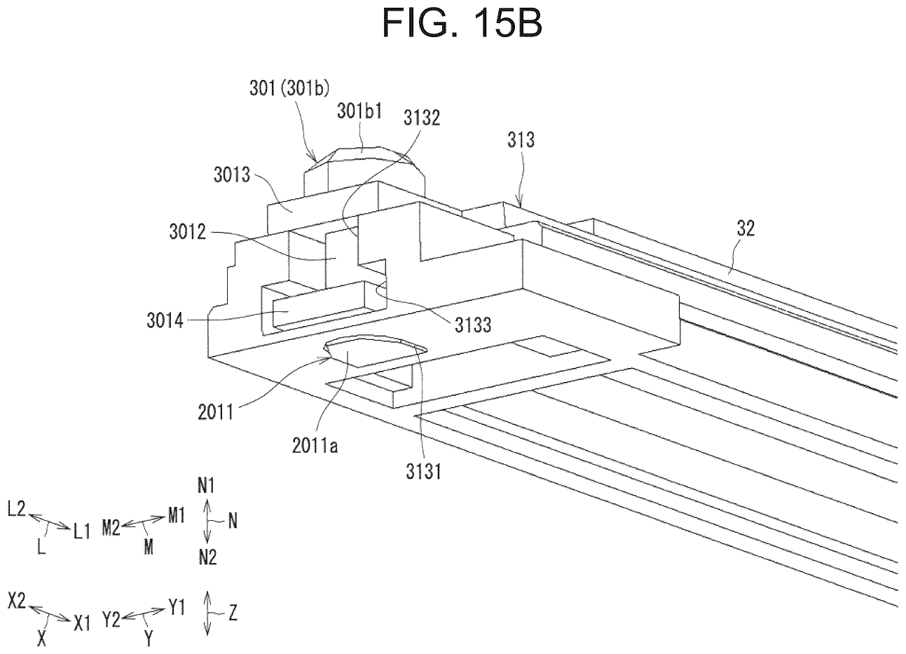

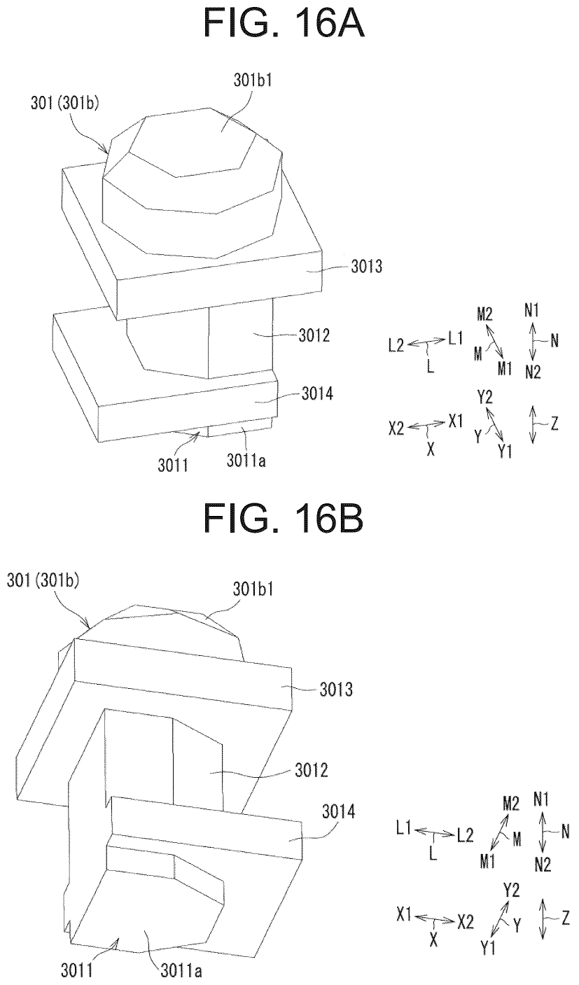

FIG. 15A is an exploded perspective view of the positioner 301b on the other side L2 and the lens holding member 313, as viewed obliquely from below. FIG. 15B is a perspective view illustrating the positioner 301b on the other side L2 attached to the lens holding member 313 as viewed obliquely from below. FIG. 16A is a perspective view of the positioner 301b on the other side L2 as viewed from above on the back side X2. FIG. 16B is a perspective view of the positioner 301b on the other side L2 as viewed from below on the front side X1.

In the present embodiment, the positioner 301 (301a, 301b) is detachably provided on the lens holding member 313 of the print head 3. The positioner 301 (301a, 301b) includes a slip-out preventor 3011 that prevents the positioner 301 from slipping out of the lens holding member 313.

In such a configuration, the positioner 301 (301a, 301b) is detachably provided on the lens holding member 313, and as a result, the ease of attaching and detaching the positioner 301 (301a, 301b) to and from the lens holding member 313 can be improved. If the positioner 301 (301a, 301b) includes the slip-out preventor 3011, it is possible to effectively prevent the positioner 301 (301a, 301b) from easily coming off the lens holding member 313.

In such an example, the positioner 301 (301a, 301b) is detachable by moving in the longitudinal direction L relative to the lens holding member 313. The lens holding member 313 includes a through hole penetrating in the optical axis direction N (thickness direction) or a recess recessed in the optical axis direction N (through hole 3131 in such an example). The slip-out preventor 3011 in the positioner 301 (301a, 301b) includes a protrusion 3011a protruding toward a side of the lens holding member 313 in the optical axis direction N (the other side N2). The protrusion 3011a is fittingly received into a through hole or a recess (through hole 3131) in the lens holding member 313.

In such a configuration, the positioner 301 (301a, 301b) is detachable by moving in the longitudinal direction L relative to the lens holding member 313, to make it easy to attach and detach the positioner 301 (301a, 301b) in the longitudinal direction L relative to the lens holding member 313. If the protrusion 3011a is provided on the positioner 301 (301a, 301b) and a through hole or a recess (through hole 3131) is provided in the lens holding member 313, a configuration in which the positioner 301 (301a, 301b) is prevented from coming off the lens holding member 313 can be easily realized.

More specifically, the positioner 301 (301a, 301b) includes a rod-shaped section 3012 extending in the optical axis direction N, and a pair of flat plates 3013 and 3014 provided on both ends of the rod-shaped section 3012 in the optical axis direction N. In the positioner 301a on the one side L1 in the longitudinal direction L, a convex area 301a1 is provided in the flat plate 3013 on the one side N1 in the optical axis direction N, opposite to the rod-shaped section 3012. In the positioner 301b on the other side L2 in the longitudinal direction L, the swing shaft 301b1 is provided in the flat plate 3013 on the one side N1 in the optical axis direction N, opposite to the rod-shaped section 3012. Sizes h1 and h2 (see FIGS. 13A and 15A) of the flat plates 3013 and 3014 in the width direction M in the optical axis direction N are larger than a size h3 (see FIGS. 13A and 15A) of the rod-shaped section 3012 in the width direction M (h1>h3, h2>h3).

The area to be positioned 302 (302a, 302b) includes a first insertion area 3132 through which the rod-shaped section 3012 is inserted in the longitudinal direction L, and a second insertion area 3133 through which the flat plate 3014 on the other side N2 is inserted in the longitudinal direction L. A size h4 of the second insertion area 3133 in the width direction M (see FIGS. 13A and 15A) is larger than the size h2 of the flat plate 3014 in the width direction M on the other side N2 by a predetermined size (h4>h2) so that the flat plate 3014 on the other side N2 can be smoothly inserted therethrough. A size h5 of the first insertion area 3132 in the width direction M (see FIGS. 13A and 15A) is larger than the size h3 of the rod-shaped section 3012 in the width direction M by a predetermined size (h5>h3) so that the rod-shaped section 3012 can be smoothly inserted therethrough. The size h4 in the width direction M of the second insertion area 3133 is larger than the size h5 in the width direction M of the first insertion area 3132 (h4>h5).

Thus, if the positioner 301 (301a, 301b) is moved in the longitudinal direction L relative to the lens holding member 313 and the protrusion 3011a is fitted into the through-holes 3131, it is possible to effectively prevent the positioner 301 (301a, 301b) from coming off the lens holding member 313.

### Second Embodiment

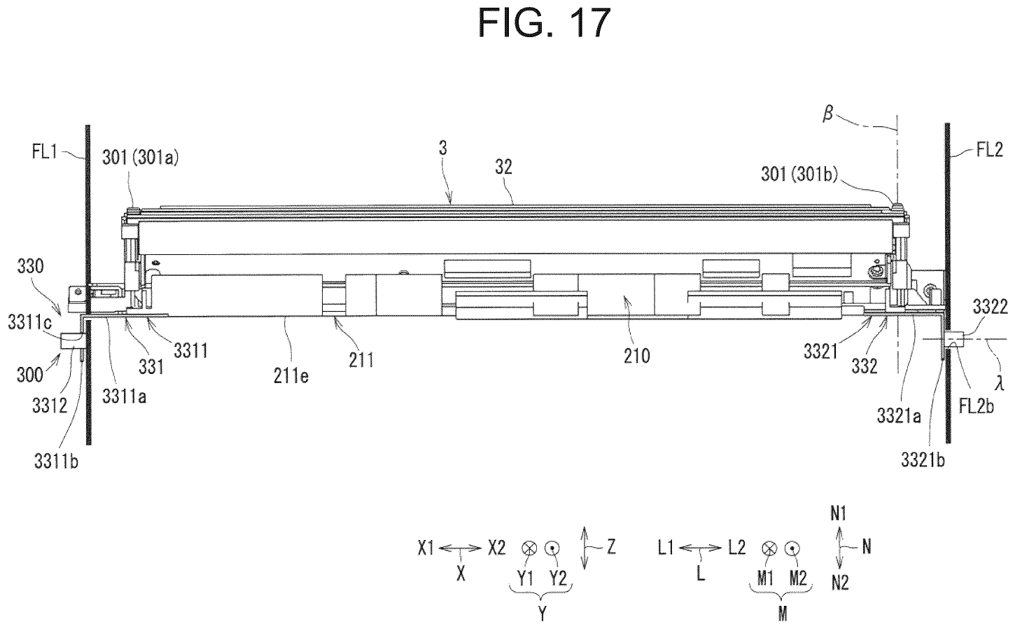

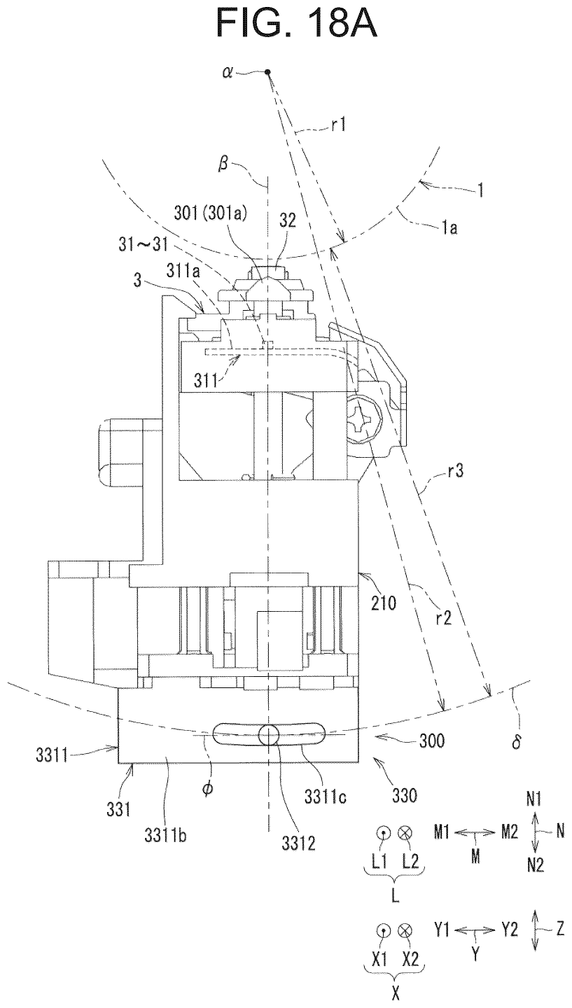

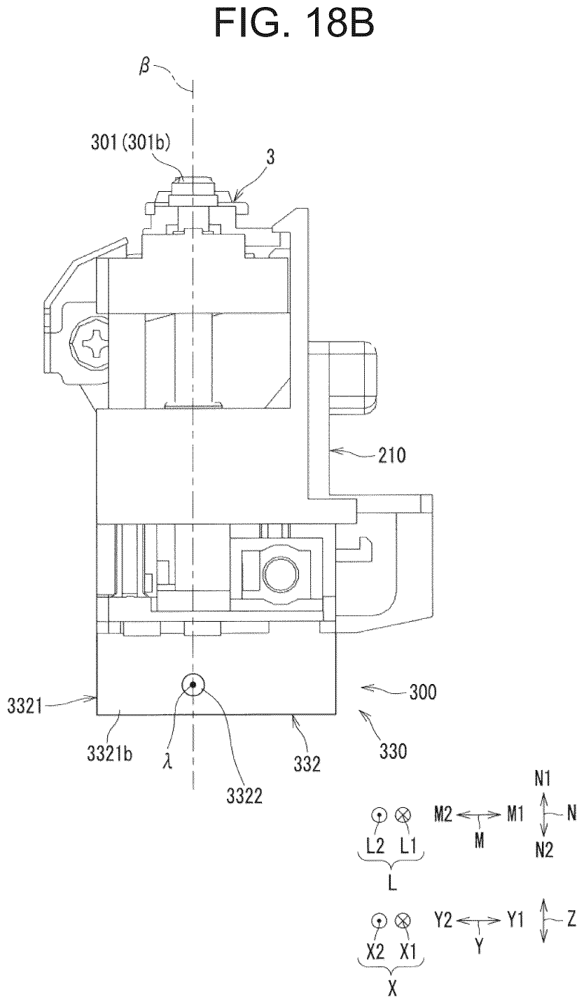

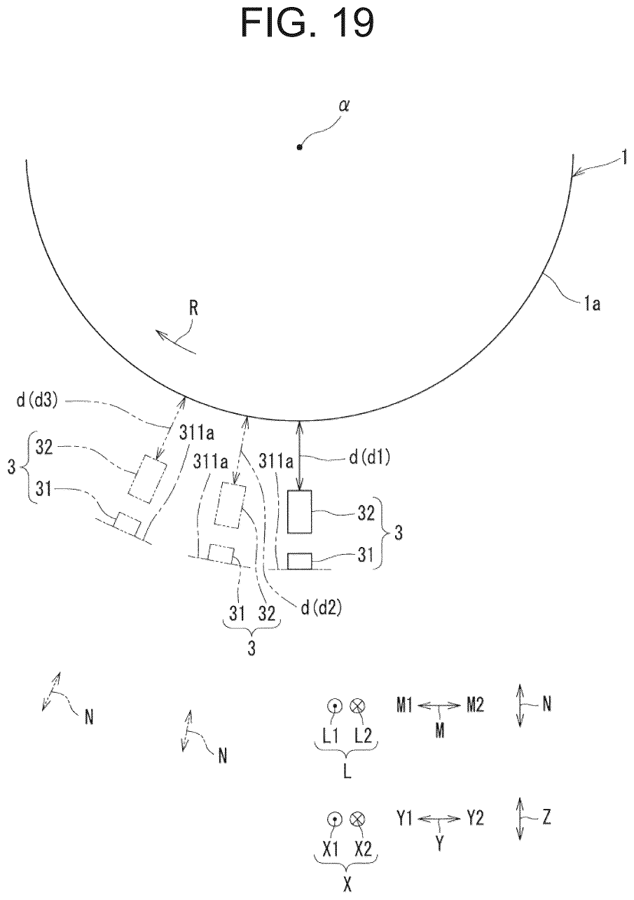

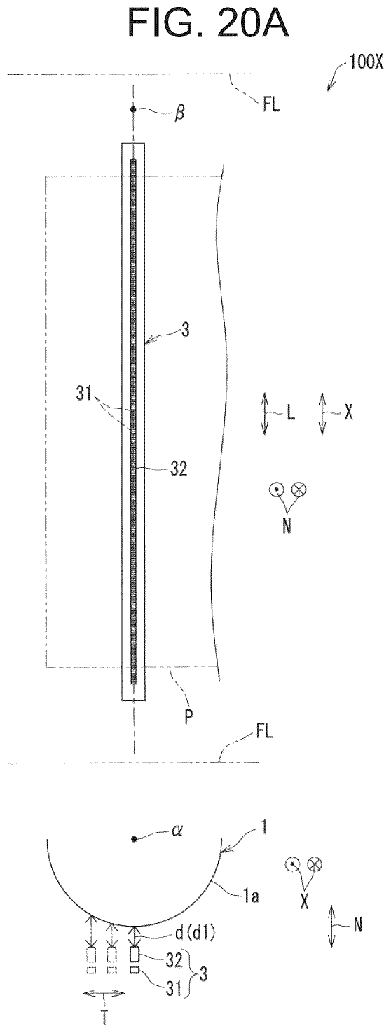

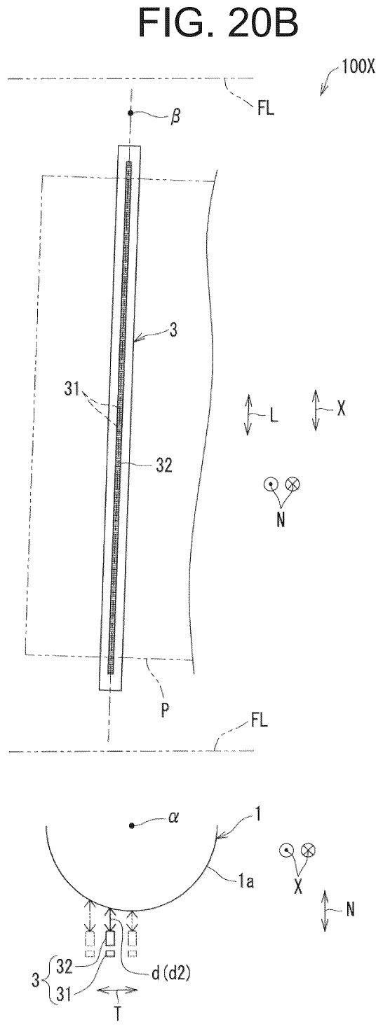

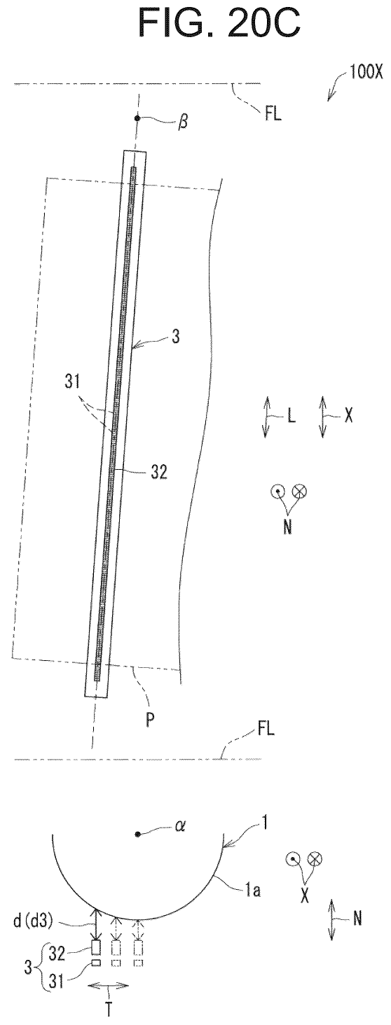

FIG. 17 is a side view illustrating another example of the positioning mechanism 300. FIGS. 18A and 18B are front and rear views of a guide mechanism 330 illustrated in FIG. 17, respectively. The tilt adjuster 230 is omitted from illustration in FIGS. 17 to 18B. FIG. 19 is a front view for explaining that regardless of the tilt of the print head 3 around the swing axis β, a distance d between the print head 3 and the photosensitive drum 1 is maintained constant, and the optical axes of the plurality of light-emitting elements 31 to 31 in the print head 3 orient toward the center of rotation (α) of the photosensitive drum 1.

The second embodiment is similar to the first embodiment except that the swing supporter 220 is removed and the guide mechanism 330 is provided in the first embodiment, and the same components are given the same reference numerals and the description of the same components will be omitted.

In the image forming apparatus 100 according to the first embodiment, as the print head 3 tilts around the swing axis β, the optical axes of the plurality of light-emitting elements 31 to 31 in the print head 3 move in parallel. The surface 1a of the photosensitive drum 1 is curved, and thus, depending on the position of light emitted by the plurality of light-emitting elements 31 to 31 on the surface 1a of the photosensitive drum 1, a beam spot on the surface 1a of the photosensitive drum 1 may not have the desired shape (preferably, be circular), which results in a deterioration in image quality.

In this regard, in the present embodiment, the positioning mechanism 300 positions the print head 3 relative to the photosensitive drum 1 so that the optical axes of the plurality of light-emitting elements 31 to 31 in the print head 3 orient toward the center of rotation (α) of the photosensitive drum 1 regardless of the tilt of the print head 3 around the swing axis β caused by the tilt adjustment mechanism 200. Here, “the optical axes of the plurality of light-emitting elements 31 to 31 orient toward the center of rotation (α) of the photosensitive drum 1” is a concept including not only a case where the optical axes of the light-emitting elements 31 to 31 pass through the center of rotation (α) of the photosensitive drum 1, but also a case where a beam spot irradiated onto the surface 1a of the photosensitive drum 1 has an acceptable shape (a shape in which the image quality is maintained).

In such a configuration, regardless of the tilt of the print head 3 around the swing axis β, the optical axes of the plurality of light-emitting elements 31 to 31 are oriented toward the center of rotation (α) of the photosensitive drum 1. Therefore, regardless of the position of light emitted by the plurality of light-emitting elements 31 to 31 on the surface 1a of the photosensitive drum 1, a beam spot on the surface 1a of the photosensitive drum 1 can be made into a desired shape (preferably, be circular), as a result of which it is possible to effectively prevent a degradation in image quality.

### Second Embodiment—1

In the present embodiment, the positioning mechanism 300 includes the guide mechanism 330 (an example of a guiding mechanism). When the print head 3 is tilted around the swing axis β by the tilt adjustment mechanism 200, while the guide mechanism 330 maintains the distance d between the print head 3 and the photosensitive drum 1, the guide mechanism 33 guides the print head 3 along the virtual arc δ so that a virtual straight line φ (see FIG. 18A) along the board surface 311a of the light-emitting element board 311 is a tangent to the virtual arc δ with an arc radius r2 (r1+r3) larger than the radius r1 of the photosensitive drum 1 and with the arc center concentric with the center of rotation (α) of the photosensitive drum 1.

In such a configuration, the guide mechanism 330 that guides the print head 3 along the virtual arc δ can be used to easily realize a configuration in which the optical axes of the plurality of light-emitting elements 31 to 31 in the print head 3 are oriented toward the center of rotation (α) of the photosensitive drum 1.

### Second Embodiment—2

In the present embodiment, the guide mechanism 330 includes a print head guide 331 and a print head pivotter 332. The print head guide 331 guides the one side L1 in the longitudinal direction L of the print head 3 relative to the image forming apparatus main body 101 along the virtual arc δ. The print head pivotter 332 allows the other side L2 in the longitudinal direction L of the print head 3 to pivot (be freely rotatable) about a pivot axis λ (see FIG. 18B) along the longitudinal direction L relative to the image forming apparatus main body 101.

In such a configuration, the print head 3 capable of pivoting around the pivot axis λ on the other side L2 in the longitudinal direction L by the print head pivotter 332, can be guided along the virtual arc δ on the one side L1 in the longitudinal direction L by the print head guide 331. This allows the print head 3 to be moved stably along the virtual arc δ.

More specifically, the print head guide 331 includes a guiding member 3311 and a guided member 3312. The guiding member 3311 is fixed to an end of the print head 3 on the one side L1 in the longitudinal direction L (in such an example, the rear surface 211e of the swinger body 211) by a fastening member (male screw) (not illustrated) or the like.

The guiding member 3311 is formed by stamping and bending a metal sheet, and includes a guiding member main body 3311a and a bent area 3311b. The guiding member body 3311a is fixed to the print head 3 and extends from the print head 3 toward the one side L1 in the longitudinal direction L. The bent area 3311b is bent in the up-down direction Z (downward in such an example) from the tip of the guiding member main body 3311a. The bent area 3311b includes an arc-shaped through-hole 3311c (see FIG. 18A) formed along the virtual arc δ. The image forming apparatus main body 101 (in such an example, the main body frame FL1 on the front side X1) includes the guided member 3312 to be inserted into the arc-shaped through hole 3311c.

The guided member 3312 is a cylindrical member provided in the image forming apparatus main body 101, and in such an example, the guided member 3312 is fixed (in such an example, fixed by crimping using a crimping process utilizing the plastic deformation of metal) to the main body frame FL1 on the front side X1 so that the axis direction of the guided member 3312 is along the rotation axis direction X of the photosensitive drum 1. The guided member 3312 protrudes from the main frame FL1 toward the front side X1. In the bent area 3311b of the guiding member 3311, the guided member 3312 is inserted into the arc-shaped through hole 3311c at a position on the front side X1 from the main frame FL1. Although the guided member 3312 has a circular shape in cross section as viewed from the axis direction, the guided member 3312 may be formed into a shape conforming to the arc-shaped through hole 3311c.

The print head pivotter 332 includes a support member 3321 and a shaft member 3322. The support member 3321 is fixed to the end of the print head 3 on the other side L2 in the longitudinal direction L (in such an example, the rear surface 211e of the swinger body 211) by a fastening member (male screw) (not illustrated) or the like.

The support member 3321 is formed by stamping and bending a metal sheet, and includes a support member main body 3321a and a bent area 3321b. The support member main body 3321a is fixed to the print head 3 and extends from the print head 3 toward the one side L2 in the longitudinal direction L. The bent area 3321b is bent in the up-down direction Z (downward in such an example) from the tip of the support member main body 3321a. The image forming apparatus main body 101 (in such an example, the main body frame FL2 on the back side X2) includes a circular through-hole FL2b (see FIG. 17) penetrating in a circular shape. The bent area 3321b includes a shaft member 3322 to be inserted into the circular through hole FL2b.

The shaft member 3322 is a cylindrical member provided at the bent area 3321b, and in such an example, the shaft member 3322 is fixed (in such an example, fixed by crimping) to the main frame FL2 so that the axis direction of the shaft member 3322 is along the rotation axis direction X of the photosensitive drum 1. The bent area 3321b of the support member 3321 is located on the front side X1 (inner side) from the main frame FL2. The shaft member 3322 is inserted into the circular through-hole FL2b in the main frame FL2 and protrudes from the main frame FL2 toward the back side X2.

In the configuration described above, the guide mechanism 330 can orient the optical axes of the plurality of light-emitting elements 31 to 31 in the print head 3 toward the center of rotation (α) of the photosensitive drum 1, regardless of the tilt of the print head 3 around the swing axis β.

### Third Embodiment

In the present embodiment, the main body side member in the first and second embodiments is a housing (in such an example, a housing 401 of the photosensitive drum 1) that rotatably supports the photosensitive drum 1 around the rotation axis α of the photosensitive drum 1 (see FIG. 8). The area to be positioned 302 (302a, 302b) is provided integrally with the housing (401). That is, the area to be positioned 302 (302a, 302b) is integrally provided with the housing (401).

In such a configuration, the area to be positioned 302 (302a, 302b) is provided integrally with the housing (401) of the photosensitive drum 1, so that there is no need to prepare a separate member for providing the area to be positioned 302 (302a, 302b) to realize a more compact and less costly image forming apparatus 100.

More specifically, the area to be positioned 302 (302a, 302b) is integrally formed with the housing 401 (see FIG. 8) on both outer sides of the photosensitive drum 1 in the rotation axis direction X in the photosensitive unit 400. The housing of the photosensitive drum 1 may be provided in the image forming apparatus main body 101.

The present disclosure is not limited to the embodiments described above and can be embodied in various other forms. Therefore, the present embodiment is to be construed in all respects as merely illustrative and not restrictive. The scope of the present disclosure is defined by the claims and is not limited in any way by the text of the specification. Furthermore, all modifications and variations within a scope equivalent to the scope of the claims are within the scope of the present disclosure.

What is claimed is:

1. An image forming apparatus comprising:
an image carrier;
a print head having a long length and including a board including a plurality of light-emitting elements arranged in a line and a lens array that focuses light emitted by the plurality of light-emitting elements onto the image carrier; and
a tilt adjuster that adjusts a tilt of the print head about a swing axis along an optical axis direction of the plurality of light-emitting elements, wherein
the image forming apparatus further includes a positioning mechanism that positions the print head relative to the image carrier to maintain a constant distance between the print head and the image carrier, regardless of the tilt of the print head about the swing axis caused by the tilt adjuster.

2. The image forming apparatus according to claim 1, wherein the positioning mechanism includes:
a positioner that is provided in the print head and determines a position of the print head relative to the image carrier; and
an area to be positioned that is provided in a main body side member being a member on a side of an image forming apparatus main body and abuts against the positioner, wherein
the area to be positioned includes an arc-shaped area concentric with a center of rotation of the image carrier and larger than a radius of the image carrier, and the arc-shaped area includes an abutment surface abutting against the positioner.

3. The image forming apparatus according to claim 2, wherein
the print head includes a lens holding member that holds the lens array and a fixing member that fixes the board or a panel, and
the positioner is provided in the lens holding member.

4. The image forming apparatus according to claim 2, wherein
the positioning mechanism further includes a biasing member that biases the positioner toward the main body side member, and
the area to be positioned is biased by the biasing member to abut against the positioner.

5. The image forming apparatus according to claim 4, wherein
the positioner includes a pair of positioners, one on each side of the print head in a longitudinal direction,
the area to be positioned includes a pair of areas to be positioned corresponding to the pair of positioners,
one of the pair of positioners includes a convex area extending in the longitudinal direction, and
the area to be positioned on one side corresponding to the positioner on the one side, of the pair of areas to be positioned, includes the arc-shaped area, and the abutment surface of the arc-shaped area abuts against the convex area of the positioner on the one side.

6. The image forming apparatus according to claim 4, wherein
the positioner includes a pair of positioners, one on each side of the print head in a longitudinal direction,
the area to be positioned includes a pair of areas to be positioned corresponding to the pair of positioners,
the positioner on the other side, of the pair of positioners, includes a swing shaft centered on the swing axis, and the print head is pivotable about the swing shaft, and
the area to be positioned on the other side corresponding to the positioner on the other side, of the pair of areas to be positioned, includes a concave area extending in the longitudinal direction, and the concave area fittingly receives the swing shaft of the positioner on the other side.

7. The image forming apparatus according to claim 3, wherein
the positioner is detachably provided in the lens holding member in the print head, and
the positioner includes a slip-out preventor that prevents the positioner from coming off the lens holding member.

8. The image forming apparatus according to claim 7, wherein
the positioner is detachable from the lens holding member in a longitudinal direction of the print head,
the lens holding member includes a through hole penetrating in the optical axis direction or a recess recessed in the optical axis direction, and
the slip-out preventor in the positioner includes a protrusion protruding toward the lens holding member in the optical axis direction, and the protrusion is fittingly received into the through hole or the recess in the lens holding member.

9. The image forming apparatus according to claim 2, wherein
the main body side member is a housing that rotatably supports the image carrier around a rotation axis of the image carrier, and
the area to be positioned is integrated with the housing.

10. The image forming apparatus according to claim 1, wherein the positioning mechanism positions the print head relative to the image carrier so that optical axes of the plurality of light-emitting elements in the print head are oriented toward a center of rotation of the image carrier, regardless of the tilt of the print head about the swing axis caused by the tilt adjuster.

11. The image forming apparatus according to claim 10, wherein the positioner includes a guiding mechanism that guides the print head along a virtual arc when the print head is tilted about the swing axis by the tilt adjuster while maintaining a distance between the print head and the image carrier, so that a virtual straight line along a board surface of the board is a tangent to the virtual arc, a center of the virtual arc is concentric with a center of rotation of the image carrier, and an arc radius of the virtual arc is larger than a radius of the image carrier.

12. The image forming apparatus according to claim 11, wherein the guiding mechanism includes a print head guide that guides one side of the print head in a longitudinal direction relative to an image forming apparatus body along the virtual arc, and a print head pivotter that allows the other side of the print head in the longitudinal direction to be pivotable about a pivot axis along the longitudinal direction relative to the image forming apparatus body.

13. The image forming apparatus according to claim 1, wherein the board is a film-like board including an organic EL diode element.
